(19) United States
(12) Patent Application Publication
(10) Pub. No.: US 2026/0223905 A1
(43) Pub. Date: Aug. 6, 2026

(54) Nutritional Supplement Compositions and Methods for Enhancing Biological Functions

(71) Applicant: Best 365 Labs Inc., Salt Lake City, UT (US)

(72) Inventors: Darren LOPEZ, West Valley City, UT (US); Dan SCHMIDT, Salt Lake City, UT (US)

(21) Appl. No.: 19/173,875

(22) Filed: Apr. 9, 2025

Related U.S. Application Data
(60) Provisional application No. 63/754,434, filed on Feb. 5, 2025.

(51) Int. Cl. A23L 33/16; A23L 33/105; A23L 33/13; A23L 33/15; A23L 33/175

(52) U.S. Cl. CPC A23L 33/16; A23L 33/105; A23L 33/13; A23L 33/15; A23L 33/175

(57) ABSTRACT

Various nutritional supplement compositions and methods are disclosed herein for enhancing various biological functions, and these compositions can be co-administered for added or synergistic effect. In some examples, liquid nutritional supplement compositions can include a liquid carrier, a mineral blend (where the mineral blend includes sodium, calcium, magnesium, potassium, and silicon each being independently present in the form of a mineral salt, a mineral oxide, or a mineral chloride), and methylated vitamin B12 and/or vitamin C. In other examples, nutritional supplement compositions can include nicotinamide adenine dinucleotide and pyrroloquinoline quinone. In other examples, nutritional supplement composition can include a methylthioninium salt, urolithin A, and pyrroloquinoline quinone. In some instances, a methylated vitamin B12 and/or nicotinamide adenine dinucleotide can also be included. These and other nutritional supplement compositions can be co-administered together and/or with a GLP-1 agonist, for example.

The present application claims the benefit of U.S. Provisional Patent Application No. 63/754,434 filed on Feb. 5, 2025, the entirety of which is incorporated herein by reference.

### BACKGROUND

Various nutritional supplement compositions exist that include many compounds that are put together to provide a well-balanced profile, including the various vitamins and minerals that the body utilizes to function properly. However, there are many benefits to providing more focused combinations of compounds within more specific weight ratios and/or dosages that can provided added benefits, particularly if a subject is seeking to enhance a more specific biological function or group of related biological functions. For example, mitochondrial health, metabolism, weight management, and other similar issues can be enhanced by combining certain nutritional compounds in more focused compositions, often providing an additive or even synergistic benefit to subjects desiring enhanced biological function.

### DETAILED DESCRIPTION

In some examples of the present disclosure, liquid nutritional supplement compositions can include from about 85 wt % to about 98 wt % aqueous liquid carrier, from about 0.5 wt % to about 5 wt % mineral blend, from about 0.25 wt % to about 3 wt % methylated vitamin B12, and from about 0.25 wt % to about 3 wt % vitamin C. In this example, the mineral blend can include sodium, calcium, magnesium, potassium, and silicon each being independently present in the form of a mineral salt, a mineral oxide, or a mineral chloride. In a second similar example, the liquid nutritional supplement composition can include an aqueous liquid carrier, from about 0.5 vol % to about 3 vol % of a mineral blend, and methylated vitamin B12 and/or vitamin C. Again, the mineral blend can include sodium, calcium, magnesium, potassium, and silicon each being independently present in the form of a mineral salt, a mineral oxide, or a mineral chloride. Also, in this example, a single dose of from about 0.5 mL to about 2.5 mL of the liquid nutritional supplement composition can include from about 1 mg to about 20 mg of the methylated vitamin B12 and/or from about 5 mg to about 20 mg of the vitamin C. In a third similar example, the liquid nutritional supplement composition can include an aqueous liquid carrier, a mineral blend, methylated vitamin B12, and vitamin C. Again, the mineral blend can include sodium, calcium, magnesium, potassium, and silicon each being independently present in the form of a mineral salt, a mineral oxide, or a mineral chloride. In this example, a single dose of from about 0.5 mL to about 2.5 mL of the liquid nutritional supplement composition can include from about 0.2 mg to about 10 mg of the mineral blend, from about 1 mg to about 20 mg of the methylated vitamin B12 and/or from about 5 mg to about 20 mg of the vitamin C. Methods of enhancing biological function can include orally administering one of these liquid nutritional supplement compositions to a subject.

In other examples, nutritional supplement compositions can include nicotinamide adenine dinucleotide in the form of NADH, NAD+, or a combination thereof, and pyrroloquinoline quinone. In this example, the nicotinamide adenine dinucleotide and the pyrroloquinoline quinone can be present in the nutritional supplement composition at a weight ratio from about 1:40 to about 1:2. Methods of enhancing biological function can include orally administering this nutritional supplement composition to a subject.

In other examples, nutritional supplement compositions can include a methylthioninium salt, urolithin A, pyrroloquinoline quinone, and methylated vitamin B12 and/or nicotinamide adenine dinucleotide. In this example, the nutritional supplement composition can have a methylthioninium salt to urolithin A weight ratio from about 1:600 to about 1:4, a methylthioninium salt to pyrroloquinoline quinone weight ratio from about 1:20 about 50:1, a methylthioninium salt to methylated vitamin B12 weight ratio from about 1:20 to about 50:1 (if present), and a methylthioninium salt to nicotinamide adenine dinucleotide weight ratio from about 2:5 to about 200:1 (if present). Methods of enhancing biological function can include orally administering this nutritional supplement composition to a subject.

In other examples, methods of enhancing biological function in a subject, e.g., supporting enhanced mitochondrial health, long-term weight management, etc., can include orally co-administering a GLP-1 agonist and a nutritional supplement composition including a methylthioninium salt, urolithin A, and pyrroloquinoline quinone. The nutrition supplement can have a methylthioninium salt to urolithin A weight ratio from about 1:600 to about 1:4, and a methylthioninium salt to pyrroloquinoline quinone weight ratio from about 1:20 to about 50:1. In accordance with this, it is notable that the GLP-1 agonist can likewise be co-administered with any of the other nutritional supplement compositions described herein (including the liquid nutritional supplement composition).

In other examples, combination therapies can be implemented that include co-administering two or more nutritional supplement compositions within a single day to a subject, including those described herein. In some examples, the two or more nutritional supplement compositions can include any two of the following four nutritional supplement compositions. A first nutritional supplement composition can be co-administered that includes from about 85 wt % to about 98 wt % liquid carrier, from about 0.5 wt % to about 5 wt % of a mineral blend, from about 0.25 wt % to about 3 wt % methylated vitamin B12, and from about 0.25 wt % to about 3 wt % vitamin C. The mineral blend, for example, can include sodium, calcium, magnesium, potassium, and silicon each being independently present in the form of a mineral salt, a mineral oxide, or a mineral chloride. A second nutritional supplement composition can be co-administered that includes nicotinamide adenine dinucleotide in the form of NADH, NAD+, or a combination thereof, and pyrroloquinoline quinone. The nicotinamide adenine dinucleotide and the pyrroloquinoline quinone can be present in the second nutritional supplement composition at a weight ratio from about 1:40 to about 1:2. A third nutritional supplement composition can be co-administered that includes a methylthioninium salt, urolithin A, and pyrroloquinoline quinone. This third nutritional supplement composition can include a methylthioninium salt to urolithin A weight ratio from about 1:600 to about 1:4 and a methylthioninium salt to pyrroloquinoline quinone weight ratio from about 1:20 about 50:1. In some examples, a third nutritional supplement composition can further include a methylated vitamin B12 having a methylthioninium salt to methylated vitamin B12 weight ratio from about 1:20 to about 50:1. A fourth nutritional supplement composition can be co-administered that includes a methylthioninium salt, e.g., methylene blue, caffeine, and L-theanine. The methylthioninium chloride and the caffeine in this example can be present at a weight ratio from about 1:75 to about 1:4, the methylthioninium chloride and the L-theanine can be present at a weight ratio from about 1:200 to about 1:10, and the caffeine and the L-theanine can be present at a weight ratio from about 1:5 to about 1:1. In some more specific examples, the caffeine of the fourth nutritional supplement composition can be provided, at least in part by guarana, green tea, or a combination thereof. Any of these nutritional supplement compositions, or any two or more of these nutritional supplement compositions (or any other others described herein) can likewise be co-administered with a GLP-1 agonist within the single day that the nutritional supplement compositions are being administered to the subject.

It is noted that when discussing the nutritional supplement compositions or any of the related methods herein, discussions of one type of example are considered applicable to other examples whether or not they are explicitly discussed in the context of that example unless expressly indicated otherwise. Thus, for example, when discussing pyrroloquinoline quinone in the context of one or more of the nutritional supplement compositions, such disclosure is also relevant to and directly supported in context of other nutritional supplement composition examples as well as any of the methods described herein, and vice versa. For simplicity and illustrative purposes, numerous specific details are set forth in order to provide a thorough understanding of the present disclosure. It will be readily apparent however, that the present disclosure can be practiced without limitation to some of these specific details. In other instances, certain methods, systems, materials, and structures have not been described in detail so as not to obscure the present disclosure.

Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

### Nutritional Supplement Compositions

In accordance with examples of the present disclosure, various nutritional supplement compositions described herein can assist with enhancing various biological functions in a subject, including mitochondrial health, cellular health, weight loss, long-term weight management, cardiovascular health, brain health and function, etc. These nutritional supplement compositions can be administered individually as single compositions, co-administered (or co-formulated) together with other nutritional supplement compositions described herein, and/or co-administered with a GLP-1 agonist, e.g., dulaglutide, exenatide, liraglutide, lixisenatide, semaglutide, tirzepatide, or the like. Example dosages are given, which may be applicable to both co-formulated nutritional supplement compositions as well as when co-administered as a separate dosage form, e.g., a prescription dosage form to be co-administered with the compositions described herein. In further detail, these nutritional supplement compositions can be suitable for oral administration via oral ingestion (swallowing), e.g., capsule, tablet, soft-gel, powder, liquid (solution or suspension), and/or can be suitable for transmucosal oral administration by transmucosal delivery, e.g., buccal, sublabial, sublingual, etc. In some instances, oral delivery may include delivery occurring by oral ingestion with a portion being delivered transmucosally within the mouth prior to or even after swallowing the bulk of the composition, e.g., liquid suspensions may provide some transmucosal delivery due to contact with mucosal tissues within the mouth. With this in mind, it is noted that though these nutritional supplement compositions can be in any of the forms recited above, in some examples herein, a nutritional supplement composition may be described more specifically as a “liquid nutritional supplement composition.” In these more specific examples, the nutritional supplement compositions will not be in the form of a dried powder, a pressed tablet, etc., as these compositions are in the form of a liquid solution or dispersion, which may be delivered orally as described above as a liquid shot or beverage and/or via soft-gel capsules, for example.

Mineral Blends in Solution with Methylated Vitamin B12 and/or Vitamin C

In accordance with this, various nutritional supplement compositions are described herein. Furthermore, a subset of liquid nutritional supplement compositions are also described herein. For example, liquid nutritional supplement compositions may include an aqueous liquid carrier, a mineral blend of various mineral salts, oxides, and/or chlorides, and one or both of methylated vitamin B12 and/or vitamin C.

In a first more specific example, the liquid nutritional supplement compositions can include from about 85 wt % to about 98 wt % liquid carrier (which may be water or predominantly water, e.g., greater than about 50 wt % based on the aqueous liquid carrier content), from about 0.5 wt % to about 5 wt % mineral blend (including sodium, calcium, magnesium, potassium, and silicon each being independently present in the form of a mineral salt, a mineral oxide, or a mineral chloride), from about 0.25 wt % to about 3 wt % methylated vitamin B12 and/or from about 0.25 wt % to about 3 wt % vitamin C. With these weight percentages, a single dose of the liquid nutritional supplement composition, based on about a 0.5 mL to 2.5 mL dose or about a 1 mL dose, can include from about 10 mg to about 75 mg of the mineral blend, from about 1 mg to about 20 mg of the methylated vitamin B12 (if present), and from about 5 mg to about 20 mg of the vitamin C (if present).

In a second example, liquid nutritional supplement compositions can include an aqueous liquid carrier, from about 0.5 vol % to about 3 vol % of a mineral blend, methylated vitamin B12, and vitamin C. Again, the mineral blend can include sodium, calcium, magnesium, potassium, and silicon each being independently present in the form of a mineral salt, a mineral oxide, or a mineral chloride. In this example, a single dose of from about 0.5 mL to about 2.5 mL of the liquid nutritional supplement composition can include from about 1 mg to about 20 mg of the methylated vitamin B12 and/or from about 5 mg to about 20 mg of the vitamin C.

In a third example, liquid nutritional supplement compositions can include an aqueous liquid carrier, a mineral blend, methylated vitamin B12, and vitamin C. Again, the mineral blend can include sodium, calcium, magnesium, potassium, and silicon each being independently present in the form of a mineral salt, a mineral oxide, or a mineral chloride. In this example, a single dose of from about 0.5 mL to about 2.5 mL of the liquid nutritional supplement composition can include from about 0.2 mg to about 10 mg of the mineral blend, from about 1 mg to about 20 mg of the methylated vitamin B12, and from about 5 mg to about 20 mg of the vitamin C.

In further detail, the liquid nutritional supplement compositions described herein can be prepared such that a single dose has a liquid volume from about 0.5 mL to about 2.5 mL and may include from about 10 mg to about 75 mg of the mineral blend, from about 1 mg to about 20 mg of the methylated vitamin B12, and from about 5 mg to about 20 mg of the vitamin C. In some examples, the mineral blend can be present in the liquid nutritional supplement composition at from about 0.5 vol % to about 3 vol %.

Regarding the mineral blend itself, in some examples, the mineral blend can include at least about 50 wt % magnesium chloride based on a total weight of the mineral blend. Thus, a majority of the mineral blend may include magnesium chloride. Regarding some of the other minerals present in the mineral blend, the sodium may be in the form of sodium chloride; the calcium may be in the form of calcium chloride, calcium carbonate, calcium citrate, calcium gluconate, etc.; the magnesium may be in the form of magnesium oxide, magnesium chloride, magnesium glycinate, etc.; the potassium may be in the form of potassium chloride, potassium chlorate, potassium citrate, potassium phosphate, potassium aspartate, potassium bicarbonate, potassium gluconate, etc.; and the silicon can be in the form of magnesium, potassium, and silicon may be in the form of silicon dioxide (silica), alkalai metal silicates (lithium, sodium, potassium, etc.), alkanine earth metal silicates (calcium, magnesium, etc.), etc.

In these and other examples of the liquid mineral supplements described herein, the liquid nutritional supplement composition can include hydrogen peroxide, which may be added or formed in situ. Furthermore, in some examples, colloidal silver can be included in the formulation. For example, colloidal silver can be included at a concentration at from about 5 ppm to about 50 ppm or from about 10 ppm to about 40 ppm (by weight) with a particle size ranging from about 3 nm to about 20 nm or from about 5 nm to about 15 nm. Other additives that may be present include black pepper, vitamin B6, vitamin E, manganese, a cannabinoid, nicotine, caffeine, L-theanine, or a combination thereof. If caffeine is included, it can be provided by a purified compound, green tea, guarana, and/or other compositions rich in caffeine. Additionally, if L-theanine is included in this composition, it can be provided by the purified compound, guarana, and/or other compositions rich in L-theanine.

In some examples, these mineral blends (or liquid nutritional supplement compositions) can be co-formulated with a GLP-1 agonist. Example GLP-1 agonists that can be delivered include one or more of dulaglutide, exenatide, liraglutide, lixisenatide, semaglutide, and/or tirzepatide. As an example, the liquid nutritional supplement compositions can be formulated to include from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg of a GLP-1 agonist per single dosage. Thus, if a liquid nutritional supplement composition is prepared to include 30 doses, then those ranges per bottle would be multiplied by 30, e.g., 60 mg to 900 mg per bottle of the GLP-agonist to be administered as 30 doses over time. Without being bound by these example ranges, semaglutide may be co-formulated, for example, with a liquid nutritional supplement composition to deliver from about 4 mg to about 15 mg of the semaglutide per single dose, or tirzepitide may be co-formulated, for example, as a liquid nutritional supplement composition to deliver from about 5 mg to about 20 mg per single dose, if included.

### Nicotinamide Adenine Dinucleotide (NAD) and Pyrroloquinoline Quinone (PQQ)

In addition to the liquid mineral supplement compositions described herein, there are also several supplement compositions that may be in the form of a solid material for delivery via a powder, tablet, capsule, etc., or may also be suspended in a liquid for delivery via a liquid solution or dispersion as described above. In one example, a supplement composition can include nicotinamide adenine dinucleotide (in the form of NADH, NAD+, or a combination thereof), and pyrroloquinoline quinone. In this example, the nicotinamide adenine dinucleotide and the pyrroloquinoline quinone can be present in the nutritional supplement composition at a weight ratio from about 1:40 to about 1:2. In some examples, a single dose of the nutritional supplement composition includes from about 50 mg to about 200 mg of the nicotinamide adenine dinucleotide and from about 5 mg to about 25 mg of the pyrroloquinoline quinone. In some examples, this nutritional supplement composition can further include urolithin A. To illustrate, the pyrroloquinoline quinone and the urolithin A can be present in the nutritional supplement composition at a weight ratio from about 1:100 to about 1:2. In some examples, from about 5 mg to about 25 mg pyrroloquinoline quinone and from about 50 mg to about 600 mg urolithin A can be present as a single tablet or in a divided dose of multiple tablets. Regarding the nicotinamide adenine dinucleotide, it may be included as part of the single tablet or divided dose of multiple tablets at from about 50 mg to about 200 mg, for example.

In some examples, the nicotinamide adenine dinucleotide can be an oral food grade compound that is at least about 99 wt % NAD+, at least about 99.5 NAD+, or at least about 99.7 wt % NAD+. By providing the nicotinamide adenine dinucleotide at a very high weight ratio of NAD+ to NADH, e.g., from 99:1 or greater, from 99.5:0.5 or greater, or from 99.7:0.3 or greater, these compositions are in their more active and usable form, which can bypass any needed conversion step in the body. Notably nicotinamide adenine dinucleotide normally has a much lower bioavailability compared to IV administration, However, by pairing the nicotinamide adenine dinucleotide with pyrroloquinoline quinone, the gap related to the bioavailability is significantly closed, as absorption and utilization is enhanced. Furthermore, it has been found that pyrroloquinoline quinone can act as a catalytic accessory factor for lactate and other dehydrogenases, which promotes oxidation of NADH to NAD+. Thus, even with lower weight ratios of NAD+ to NADH than that described above, the presence of the pyrroloquinoline quinone can drive the weight ratio towards the NAD+ species of the nicotinamide adenine dinucleotide.

In some examples, these nutritional supplement compositions can be co-formulated with a GLP-1 agonist. Example GLP-1 agonists that can be delivered include one or more of dulaglutide, exenatide, liraglutide, lixisenatide, semaglutide, and/or tirzepatide. As an example, a nutritional supplement composition can be formulated to include from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg of a GLP-1 agonist per single dosage. Thus, if a nutritional supplement composition is prepared to include 1 tablet per dose, then those ranges would be applicable per single tablet. Where 2 tablets are used to provide one dose, then those ranges would be divided in half per table to provide the full dose with 2 tablets, etc. Without being bound by these example ranges, if a GLP-1 agonist is included, the semaglutide may be co-formulated, for example, with a nutritional supplement composition to deliver from about 4 mg to about 15 mg of the semaglutide per single dose, or the tirzepitide may be co-formulated, for example, with a nutritional supplement composition to deliver from about 5 mg to about 20 mg per single dose.

The single dose can be in the form of a single tablet or capsule, for example, or may be in the form of multiple tablets or capsules, e.g., the dose may be divided among multiple tablets or capsules. In some examples, the nutritional supplement can include an excipient blend of microcrystalline cellulose, magnesium stearate, silicon dioxide, and/or dicalcium phosphate. Any or all of these compounds may be included to form a tablet, for example, as these compounds work well together for providing various functions, including tablet consistency, pressure and temperature stability, uniform hardness, etc. Furthermore, this excipient blend can also provide some controlled or modulated release and/or protection of the active ingredients as they pass through the stomach and into the intestines.

Methylthioninium Salt, Urolithin A, and Pyrroloquinoline Quinone (PQQ) Including Examples with Methylated Vitamin B12

In other examples, a nutritional supplement composition can include a methylthioninium salt, urolithin A, and pyrroloquinoline quinone, and in some examples, may further include methylated vitamin B12 and/or nicotinamide adenine dinucleotide. In this example, a methylthioninium salt to urolithin A weight ratio can be from about 1:600 to about 1:4, and a methylthioninium salt to pyrroloquinoline quinone weight ratio can be from about 1:20 about 50:1. In examples where the methylated vitamin B12 is included, it may be present at a methylthioninium salt to methylated vitamin B12 weight ratio from about 1:20 to about 50:1. In some examples, a single oral dose (or a divided dose from multiple tablets/capsules) can include from about 1 mg to about 25 mg of the methylthioninium salt, from about 100 mg to about 600 mg of urolithin A, and from about 0.5 mg to about 20 mg of the pyrroloquinoline quinone. If the methylated vitamin B12 is included, it may be included therewith at from about 0.5 mg to about 20 mg. In some examples, the methylthioninium salt and the pyrroloquinoline quinone are present at a weight ratio from about 1:20 to about 30:1. In other examples, a single oral dose (single or divided dosage form) can include from about 10 mg to about 200 mg of the nicotinamide adenine dinucleotide. As previously mentioned, the nicotinamide adenine dinucleotide can include both NAD+ and/or NADH. However, in some examples, the compound can be in the form of at least about 99 wt % NAD+, at least about 99.5 NAD+, or at least about 99.7 wt % NAD+. By providing the nicotinamide adenine dinucleotide at a very high weight ratio of NAD+ to NADH, e.g., from 99:1 or greater, from 99.5:0.5 or greater, or from 99.7:0.3 or greater, these compositions are in their more active and usable form, which can bypass any needed conversion step in the body. In other examples, the urolithin A and the pyrroloquinoline quinone can be present at a urolithin A to pyrroloquinoline quinone weight ratio from about 5:1 to about 1200:1. In still other examples, the methylthioninium salt is in the form of methylthioninium chloride. In further detail, as described previously, this nutritional supplement can include an excipient blend of microcrystalline cellulose, magnesium stearate, silicon dioxide, and/or dicalcium phosphate. Any or all of these compounds may be included to form a tablet, for example, as these compounds work well together for providing various functions as described previously. Notably, this particular composition that includes methylthioninium salt, urolithin A, and pyrroloquinoline quinone (and in some examples, may further include methylated vitamin B12) works well when administered with one of the liquid nutritional supplement compositions as previously described.

Again, these nutritional supplement compositions can be co-formulated with a GLP-1 agonist. Example GLP-1 agonists that can be delivered include one or more of dulaglutide, exenatide, liraglutide, lixisenatide, semaglutide, and/or tirzepatide. As an example, a nutritional supplement composition can be formulated to include from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg of a GLP-1 agonist per single dosage. Thus, if a nutritional supplement composition is prepared to include 1 tablet per dose, then those ranges would be applicable per single tablet. Where 2 tablets are used to provide one dose, then those ranges would be divided in half per table to provide the full dose with 2 tablets, etc. Without being bound by these example ranges, if a GLP-1 agonist is included, the semaglutide may be co-formulated, for example, with a nutritional supplement composition to deliver from about 4 mg to about 15 mg of the semaglutide per single dose, or the tirzepitide may be co-formulated, for example, with a nutritional supplement composition to deliver from about 5 mg to about 20 mg per single dose.

### Methods of Enhancing Biological Functions

Various health conditions may be treated or biological activity associated with certain biological systems can be improved by administering the nutritional supplement compositions of the present disclosure. In some instances, multiple nutritional supplement compositions can be co-administered together or within the same day to further enhance treatment and/or improve biological. Collectively, treating health conditions or improving the function of biological systems in a subject is collectively referred to herein as “enhancing biological function(s).”

Enhancing Biological Functions with Mineral Blends in Solution Delivered with Methylated Vitamin B12 and/or Vitamin C

In accordance with examples of the present disclosure, methods of enhancing biological functions in a subject can include orally administering a liquid nutritional supplement composition including a liquid carrier, a mineral blend, methylated vitamin B12, and vitamin C. The mineral blend can include sodium, calcium, magnesium, potassium, and silicon each being independently present in the form of a mineral salt, a mineral oxide, or a mineral chloride. For example, the liquid nutritional supplement compositions can include from about 85 wt % to about 98 wt % liquid carrier (which may be water or predominantly water, e.g., greater than about 50 wt % based on the aqueous liquid carrier content), from about 0.5 wt % to about 5 wt % mineral blend (including sodium, calcium, magnesium, potassium, and silicon each being independently present in the form of a mineral salt, a mineral oxide, or a mineral chloride), from about 0.25 wt % to about 3 wt % methylated vitamin B12, and from about 0.25 wt % to about 3 wt % vitamin C. Alternatively, the liquid nutritional supplement composition can include the aqueous liquid carrier, from about 0.5 vol % to about 3 vol % of the mineral blend, the methylated vitamin B12, and the vitamin C. In this example, a single dose can be delivered via about 0.5 mL to about 2.5 mL of the liquid nutritional supplement composition, which includes from about 1 mg to about 20 mg of the methylated vitamin B12 and from about 5 mg to about 20 mg of the vitamin C. In still another example, the liquid nutritional supplement composition can include the aqueous liquid carrier, the mineral blend, the methylated vitamin B12, and the vitamin C. In this example, a single dose can be delivered via about 0.5 mL to about 2.5 mL of the liquid nutritional supplement composition which includes from about 0.2 mg to about 10 mg of the mineral blend, from about 1 mg to about 20 mg of the methylated vitamin B12, and from about 5 mg to about 20 mg of the vitamin C.

This liquid nutritional supplement composition can be co-administered with a GLP-1 agonist at the same time or at different times during a single day. Example GLP-1 agonists that can be delivered include one or more of dulaglutide, exenatide, liraglutide, lixisenatide, semaglutide, and/or tirzepatide. Single doses of the GLP-1 agonist can be co-administered, for example, at from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg.

In some examples, the liquid nutritional supplement composition can be co-administered or co-formulated with from about 10 mg to about 200 mg nicotinamide adenine dinucleotide (in the form of NADH, NAD+, or a combination thereof) to the subject together or within a single day. Likewise, the liquid nutritional supplement composition can be co-administered with any of the other nutritional supplement compositions described herein.

Combining methylated vitamin B12 with the solution or dispersion of mineral blends as described herein can provide a synergistic benefit to a subject, particularly as it relates to the presence of the magnesium content of the mineral blends, e.g., magnesium chloride. For example, these nutritional supplement compositions can provide for enhancing methylation, energy production, and neurological function. More specific health benefits supported by clinical evidence can include treatment of neurological disorders, e.g., peripheral neuropathy, migraines, etc.; treatment of mental health disorders and improvement in cognitive function, e.g., depression and/or anxiety, cognitive decline, etc.; enhancing health or treating cardiovascular issues, e.g., hypertension, heart failure, etc.; enhancing metabolic and/or immune health, e.g., type 2 diabetes, detoxification, etc.; treating musculoskeletal disorders or improving musculoskeletal health, e.g., osteoporosis, muscle cramps, etc.; and/or treating methylation support or treatment, e.g., MTHFR mutations.

As mentioned, neurological disorders can benefit from the liquid nutritional supplement compositions described herein. For example, methylated vitamin B12 can reduce peripheral neuropathy by repair of nerve myelin sheaths to reduce neuropathic pain, and the magnesium, e.g., magnesium chloride, can assist with regulation of NMDA receptors to calm nerve hyperexcitability. Thus, this combination can be useful for support of subjects suffering from diabetic neuropathy, chemotherapy-induced neuropathy, and other forms of neuropathy. Regarding migraines, the methylated vitamin B12 can reduce homocysteine (a migraine trigger) and the magnesium can improve cerebral blood flow and reduce cortical spreading depression.

Regarding mental health and cognitive function, treatment of depression and anxiety can be enhanced via inclusion of the methylated vitamin B12 in the liquid nutritional supplement compositions described herein, while the magnesium content of the mineral blend can enhance GABA activity to reduce stress. Cognitive decline can be ameliorated as well, as the methylated vitamin B12 can prevent or slow brain atrophy in dementia and the magnesium content from the mineral blend can cross the blood-brain barrier to improve memory.

Cardiovascular health can also be enhanced (or treated) via the liquid nutritional supplement compositions described herein. As an example, hypertension can be treated via the magnesium content in the mineral blend by relaxing the blood vessels and lowering BP8. The methylated vitamin B12 can reduce homocysteine (linked to atherosclerosis). The combined presence of the methylated vitamin B12 and the magnesium content can likewise synergistically lower the incidence of stroke (or lower stroke risk). Regarding heart failure, magnesium can improve cardiac rhythm and the methylated vitamin B12 can reduce risks of heart failure (B12 deficiency exacerbates cardiomyopathy).

Metabolic and immune health can also be enhanced (or treated) via the liquid nutritional supplement compositions described herein. For example, type 2 diabetes can be ameliorated because the magnesium from the mineral blend can enhance insulin sensitivity and the methylated vitamin B12 can be beneficial for subjects with diabetic neuropathy. For example, vitamin B12 and magnesium intake can result in lower HOMA-IR scores. Detoxification can also occur by this combination, as vitamin methylated vitamin B12 can drive glutathione synthesis and the magnesium from the mineral blend can activate MAT1A for toxin clearance. Thus, this combination can provide additional heavy metal toxicity clearance and liver support.

Musculoskeletal health can also be enhanced (or treated) via the liquid nutritional supplement compositions described herein. For example, osteoporosis can be treated or ameliorated via the methylated vitamin B12, as it is effective at regulating osteoblast activity. Furthermore, the magnesium present in the mineral blend can improve calcium and vitamin D absorption. Muscle cramps can likewise be ameliorated, particularly in MTHFR gene carriers, as it can alleviate muscle spasms while the methylated vitamin B12 can reduce exercise-induced fatigue.

The liquid nutritional supplement compositions of the present disclosure can also provide methylation support for subjects suffering from various gene mutations, such as the MTHFR gene mutation. For example, methylated vitamin B12 can bypass folate cycle blockages and the magnesium of the mineral blend can reactivate SAMe production for DNA repair. This combination can address symptoms such as fatigue, brain fob, recurrent miscarriages, etc.

Enhancing biological functions as it relates to these conditions described above and others can benefit from both the highly bioavailable magnesium of the mineral blend in solution along with the most usable form of vitamin B12, i.e. methylated vitamin B12 or methylcobalamin. Example dosages can include providing the mineral blend so that one dose provides about 200 mg to about 600 mg or from about 300 mg to about 550 mg of the magnesium salt, oxide, or chloride content. In some examples, the magnesium can be in the form of magnesium chloride, which is more bioavailable than magnesium oxide. As the mineral blend typically includes the magnesium salt, oxide, or chloride at greater than about 50 wt % (based on the total concentration of the mineral blend in solution), these amounts in milligrams may be present in solution for appropriate dosing. Furthermore, the methylated vitamin B12 content can be included in as little as about 1 mg up to about 20 mg per dose, or daily dose.

Enhancing Biological Functions with Nicotinamide Adenine Dinucleotide (NAD) and Pyrroloquinoline Quinone (PQQ)

In an alternative example, methods of enhancing biological functions in a subject can include orally administering a nutritional supplement composition including nicotinamide adenine dinucleotide (in the form of NADH, NAD+, or a combination thereof), and pyrroloquinoline quinone. The nicotinamide adenine dinucleotide and the pyrroloquinoline quinone can be present in the nutritional supplement composition at a weight ratio from about 1:40 to about 1:2, for example. A few example biological functions that can be enhanced include mitochondrial function, biogenesis, NAD+ production and utilization (increased oxidation from NADH to NAD+), cellular metabolism, energy production, antioxidant defense, energy brain health and function, cellular function, etc.

In accordance with this, there has found to be a synergistic effect with pyrroloquinoline quinone promoting the oxidation of NADH to NAD+ and increasing the weight ratio of NAD+ to NADH in the composition. This combination also can enhance NAD+ dependent sirtuin activity, particularly SIRT1 and SIRT3 activity. Furthermore, this combination can support mitochondrial function and biogenesis, which indirectly supports NAD+ production and utilization. Thus, this combination of nicotinamide adenine dinucleotide and pyrroloquinoline quinone can positively impact cellular metabolism, energy production, antioxidant defense compared to NAD+ precursors alone, etc.

This method can also include co-administering with other nutritional supplement compositions as described herein, such as a nutritional supplement composition including from about 85 wt % to about 98 wt % liquid carrier (which may be water or predominantly water, e.g., greater than about 50 wt % based on the aqueous liquid carrier content), from about 0.5 wt % to about 5 wt % mineral blend (including sodium, calcium, magnesium, potassium, and silicon each being independently present in the form of a mineral salt, a mineral oxide, or a mineral chloride), from about 0.25 wt % to about 3 wt % methylated vitamin B12, and from about 0.25 wt % to about 3 wt % vitamin C. Alternatively or additionally, one or both of these nutritional supplement compositions can be co-administered with a nutritional supplement composition including a methylthioninium salt, urolithin A, and pyrroloquinoline quinone (and in some examples, further including methylated vitamin B12). The methylthioninium salt to urolithin A weight ratio can be from about 1:600 to about 1:4, the methylthioninium salt to pyrroloquinoline quinone weight ratio can be from about 1:20 to about 50:1, and if included, the methylthioninium salt to methylated vitamin B12 weight ratio can be from about 1:20 to about 50:1. In some examples, this nutritional supplement composition can be co-administered with a GLP-1 agonist at the same time or at different times during a single day. Example GLP-1 agonists that can be delivered include one or more of dulaglutide, exenatide, liraglutide, lixisenatide, semaglutide, and/or tirzepatide. Single doses of the GLP-1 agonist can be co-administered, for example, at from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg.

Combining nicotinamide adenine dinucleotide (particularly NAD+ at a high NAD+ to NADH weight ratio) with pyrroloquinoline quinone can provide a synergistic benefit to a subject. For purposes of the clarity, the nicotinamide adenine dinucleotide with a high weight ratio of NAD+, e.g., at least 99 wt %, at least 99.5 wt %, at least 99.7 wt %, will be described in this section as NAD+, though lower levels of NAD+ can be used due to the oxidation effect that pyrroloquinoline quinone has on NADH, promoting its conversion to NAD+. In some examples, these nutritional supplement compositions can promote mitochondrial biogenesis, as NAD+ fuels their energy output via sirtuin activation (SIRT1/SIRT3) and pyrroloquinoline quinone can activate PGC-1α/NRF-1/2 pathways to grow new mitochondria. Antioxidant defense may also occur as NAD+ can recycle glutathione and repairs oxidative DNA damage and pyrroloquinoline quinone neutralizes free radicals at from about 100 to 1,000 times more effectively than vitamin C. Metabolic Flexibility may also be obtained as NAD+ can improve insulin sensitivity, while pyrroloquinoline quinone reduces hepatic fat accumulation and enhances lipid oxidation. These and other mechanisms can promote weight loss, enhance muscle mass, and ameliorate liver disease, for example.

Other conditions that can be treated with this combination of compounds may include age-related muscle atrophy and sarcopenia, as NAD+ can preserve muscle NAD+ pools that are involved heavily in ATP synthesis, while pyrroloquinoline quinone can reduce muscle inflammation (IL-6, TNF-α) and enhance mitochondrial density in subjects of advanced age. This combination, for example, can improve grip strength and reduce fibrosis in preclinical models. Non-alcoholic fatty liver disease (NAFLD) can also be treated with the combination of NAD+ and pyrroloquinoline quinone, as pyrroloquinoline quinone can lower hepatic triglycerides, e.g., by about 40%, via AMPK activation and suppresses lipogenesis genes (FASN, SCD1), and NAD+ can reverse mitochondrial dysfunction in hepatocytes, reducing oxidative stress. Furthermore, this combination can improve ALT/AST levels in obese individuals within several weeks, e.g., within about 12 weeks. The combination of NAD+ and pyrroloquinoline quinone can also provide support and treatment for neurodegenerative disorders, such as Alzheimer's disease or Parkinson's disease. For example, pyrroloquinoline quinone can protect neurons from Aβ/tau toxicity and increase NGF production, e.g., by about 40%, while NAD+ can restore a healthy NAD+/NADH balance, rescuing synaptic plasticity in Alzheimer's models. From a practical perspective, this combination can improve memory scores in elderly adults, primarily due to the pyrroloquinoline quinone, e.g., up to about 15% in about 12 weeks. The combination of NAD+ and pyrroloquinoline quinone can also be beneficial for cardiovascular inflammation. For example, NAD+ can reduce aortic stiffness and improves endothelial function, and pyrroloquinoline quinone can lower LDL oxidation and inhibits NLRP3 inflammasome activation in arteries. From a practical perspective, this combination can reduce post-vaccine cardiac inflammation markers (hs-CRP, IL-6), primarily due to the pyrroloquinoline quinone, e.g., by about 30%. The combination of NAD+ and pyrroloquinoline quinone can also be beneficial for treatment related to obesity and/or metabolic syndrome. For example, pyrroloquinoline quinone can reduce visceral fat by about 20% in HFD-fed rodents via UCP1 activation, while NAD+ can enhance brown adipose thermogenesis and glucose uptake. This combination, for example, can lower HOMA-IR scores, e.g., by about 25% in prediabetic models. The combination of NAD+ and pyrroloquinoline quinone can also be beneficial for immune dysregulation, as the NAD+ can boost T-cell function and reduce senescence-associated cytokines. The pyrroloquinoline quinone can modulate gut microbiota (firmicutes/bacteroidetes ratio), lowering systemic inflammation. Skin aging and UV damage can also benefit from the combination of NAD+ and pyrroloquinoline quinone, as the NAD+ can repair UV-induced DNA damage via PARP activation and the pyrroloquinoline quinone can stimulate collagen synthesis and reduce MMP-1 expression, e.g., by about 50%. Additionally, the combination of NAD+ and pyrroloquinoline quinone can also be beneficial for stabilizing circadian rhythms, e.g., treat circadian rhythm disorders. For example, the NAD+ can regulate CLOCK/BMAL1 genes to stabilize sleep-wake cycles and the pyrroloquinoline quinone reduce cortisol spikes and improve sleep quality.

Enhancing Biological Functions with Methylthioninium Salt, Urolithin A, and Pyrroloquinoline Quinone (PQQ) with Methylated Vitamin B12

In another alternative example, methods of enhancing biological functions in a subject, e.g., enhancing mitochondrial health, supporting weight loss, managing long-term management, enhance nicotinamide adenine dinucleotide production, enhance mitochondrial mitophagy, etc., can include orally administering a nutritional supplement composition including a methylthioninium salt, urolithin A, and pyrroloquinoline quinone. In some examples, the nutritional supplement composition can further include methylated vitamin B12. The nutritional supplement composition can have, for example, a methylthioninium salt to urolithin A weight ratio from about 1:600 to about 1:4, a methylthioninium salt to pyrroloquinoline quinone weight ratio from about 1:20 to about 50:1, and if present, a methylthioninium salt to methylated vitamin B12 weight ratio from about 1:20 to about 50:1.

This method can also include co-administering with other nutritional supplement compositions as described herein. For example, this nutritional supplement can be co-administered with one of the liquid nutritional supplement compositions described herein (again at the same time or at different times during a single day). One of the liquid mineral supplement compositions that can be co-delivered may include from about 85 wt % to about 98 wt % liquid carrier (which may be water or predominantly water, e.g., greater than about 50 wt % based on the aqueous liquid carrier content), from about 0.5 wt % to about 5 wt % mineral blend (including sodium, calcium, magnesium, potassium, and silicon each being independently present in the form of a mineral salt, a mineral oxide, or a mineral chloride), from about 0.25 wt % to about 3 wt % methylated vitamin B12, and from about 0.25 wt % to about 3 wt % vitamin C. The method may alternatively or additionally include the co-administration of about 10 mg to about 200 mg nicotinamide adenine dinucleotide in the form of NADH, NAD+, or a combination thereof to the subject on a daily basis. In some examples, the nicotinamide adenine dinucleotide can include both NAD+ and/or NADH. However, in other examples, the compound can be in the form of at least about 99 wt % NAD+, at least about 99.5 NAD+, or at least about 99.7 wt % NAD+. By providing the nicotinamide adenine dinucleotide at a very high weight ratio of NAD+ to NADH, e.g., from 99:1 or greater, from 99.5:0.5 or greater, or from 99.7:0.3 or greater, these compositions are in their more active and usable form, which can bypass any needed conversion step in the body.

In some examples, this nutritional supplement composition can be co-administered with a GLP-1 agonist at the same time or at different times during a single day. Example GLP-1 agonists that can be delivered include one or more of dulaglutide, exenatide, liraglutide, lixisenatide, semaglutide, and/or tirzepatide. In some examples, this nutritional supplement composition can be co-administered with a GLP-1 agonist at the same time or at different times during a single day. Example GLP-1 agonists that can be delivered include one or more of dulaglutide, exenatide, liraglutide, lixisenatide, semaglutide, and/or tirzepatide. Single doses of the GLP-1 agonist can be co-administered, for example, at from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg.

Enhancing Biological Functions with Nutritional Supplement Composition and GLP-1 Agonist

In another example of a more specific treatment protocol, methods of supporting enhanced mitochondrial health or long-term weight management in a subject can include orally co-administering a GLP-1 agonist and a nutritional supplement composition. The nutritional supplement composition can include a methylthioninium salt, urolithin A, and pyrroloquinoline quinone. This nutritional supplement composition can include a methylthioninium salt to urolithin A weight ratio from about 1:600 to about 1:4, and a methylthioninium salt to pyrroloquinoline quinone weight ratio from about 1:20 to about 50:1. In some examples, the nutritional supplement composition can further include a methylated vitamin B12 at a methylthioninium salt to methylated vitamin B12 weight ratio from about 1:20 to about 50:1. Thus, for example, a single oral dose (which may be a single tablet or capsule or divided amongst multiple tablets or capsules) may include from about 1 mg to about 25 mg of the methylthioninium salt, from about 100 mg to about 600 mg of urolithin A, and from about 0.5 mg to about 20 mg of the pyrroloquinoline quinone. If the methylated vitamin B12 is included, the nutritional supplement composition can include from about 0.5 mg to about 20 mg methylated vitamin B12. In further detail, the nutritional supplement composition that is orally delivered can include an excipient blend of microcrystalline cellulose, magnesium stearate, silicon dioxide, and dicalcium phosphate, for example.

### Enhancing Biological Functions With Combination Therapies

In other examples, combination therapies can include co-administering two or more nutritional supplement compositions within a single day to a subject. The two or more nutritional supplement compositions can include a first, second, third, and/or fourth nutritional supplement. The first nutritional supplement composition can be a liquid nutritional supplement composition including from about 85 wt % to about 98 wt % liquid carrier, from about 0.5 wt % to about 5 wt % of a mineral blend, from about 0.25 wt % to about 3 wt % methylated vitamin B12, and from about 0.25 wt % to about 3 wt % vitamin C. The mineral blend may include sodium, calcium, magnesium, potassium, and silicon each being independently present in the form of a mineral salt, a mineral oxide, or a mineral chloride. The second nutritional supplement composition can include nicotinamide adenine dinucleotide (in the form of NADH, NAD+, or a combination thereof) and pyrroloquinoline quinone. The nicotinamide adenine dinucleotide and the pyrroloquinoline quinone can be present in the second nutritional supplement composition at a weight ratio from about 1:40 to about 1:2. The third nutritional supplement composition can include a methylthioninium salt, urolithin A, and pyrroloquinoline quinone. This third nutritional supplement composition can have a methylthioninium salt to urolithin A weight ratio from about 1:600 to about 1:4 and a methylthioninium salt to pyrroloquinoline quinone weight ratio from about 1:20 to about 50:1. In some examples, the third nutritional supplement composition further includes a methylated vitamin B12 having a methylthioninium salt to methylated vitamin B12 weight ratio from about 1:20 to about 50:1. The fourth nutritional supplement composition can include a methylthioninium salt, caffeine, and L-theanine. In this example, the methylthioninium chloride and the caffeine can be present at a weight ratio from about 1:75 to about 1:4, the methylthioninium chloride and the L-theanine can be present at a weight ratio from about 1:200 to about 1:10, and the caffeine and the L-theanine can be present at a weight ratio from about 1:5 to about 1:1. In some examples, the caffeine of the fourth nutritional supplement composition is provided, at least in part by guarana, green tea, or a combination thereof. Any of these four combinations (or other combinations as described herein), can be co-administered with a GLP-1 agonist together or at least within the same day that the other compositions are delivered to the subject, e.g., single doses of the GLP-1 agonist at from about 0.5 mg to about 20 mg, from about 1 mg to about 20 mg, from about 2 mg to about 20 mg, from about 3 mg to about 20 mg, from about 3 mg to about 15 mg, or from about 3 mg to about 10 mg.

### Compounds for Nutritional Supplement Compositions and Methods of Enhancing Biological Functions

Mineral Blends (Mineral Oxides, Chlorides, and/or Salts)

In examples of the present disclosure, liquid mineral supplement compositions of the present disclosure can include mineral blends including sodium, calcium, magnesium, potassium, and silicon. Each of these can independently be in the form of a mineral salt, a mineral oxide, or a mineral chloride. The mineral blends can be sourced from a liquid solution or dispersion that is primarily an aqueous solution, e.g., predominantly water, and can be referred to herein as mineral oxides, chlorides, and/or salts. To illustrate some examples, mineral blends may include sodium chloride, calcium, chloride, potassium chlorate, magnesium chloride (or magnesium oxide), and silicon dioxide (or silica). Other forms of oxides, chlorides, or salts can be alternatively used, calcium in the form of calcium carbonate, calcium citrate, calcium gluconate, etc.; magnesium in the form of magnesium glycinate, etc.; potassium in the form of potassium chlorate, potassium citrate, potassium phosphate, potassium aspartate, potassium bicarbonate, potassium gluconate, etc.; and the silicon in the form of alkali metal silicates (lithium, sodium, potassium) or alkaline earth metal silicates (calcium, magnesium, etc.). Magnesium chloride and/or the sodium chloride, for example, can provide the benefits of a digestive aid, as the chloride is used in the stomach in the formation of stomach acid, e.g., HCl. Potassium chlorate can contribute as a strong oxidizer and can benefit oral health care, for example. Magnesium oxide can provide the benefits of an antacid compound. These mineral oxides, chlorides, and/or salts, or mineral blends, as described herein can be included in the liquid nutritional supplement compositions in aggregate at from about 0.5 wt % to about 5 wt %, from about 1 wt % to about 4.5 wt %, or from about 1.5 wt % to about 4 wt %.

In further detail, when the mineral blend (or mineral oxides, chlorides, and/or salts) are formulated in an aqueous suspension or solution, for example, the presence of the mineral oxides, chlorides, and/or salts in combination with water and other formulations therewith can result in liberating or forming hydrogen peroxide, which can also have several health benefits. Without being limited and for example purposes, the amount of hydrogen peroxide in solution (liberated or otherwise) may be from about 0.01 wt % to about 0.5 wt %, from about 0.01 wt % to about 0.25 wt %, from about 0.01 wt % to about 0.1 wt %, or from about 0.02 wt % to about 0.1 wt %. Example health benefits include bringing additional oxygen into the body. Most diseases proliferate when there is inadequate oxygen in the body, so the presence of hydrogen peroxide being formed in an aqueous liquid suspension can likewise have healing properties related to reduction of pain, detoxification of the body, and eliminating infection, for example.

In addition to the above-identified mineral oxides, chlorides, and/or salts, there may be other oxides, chlorides, salts, and/or colloidal components included. For example, the mineral blends may include colloidal silver, e.g., from about 5 ppm to about 50 ppm or from about 10 ppm to about 40 ppm with a particle size from about 3 nm to about 20 nm or from about 5 nm to about 15 nm. Colloidal silver in the form of small elemental particles or “colloids” at relatively low doses can be an effective antimicrobial and can also promote healing properties, e.g., wound healing, gut health, etc., and can support the immune system. In some examples, colloidal silver used herein can be sized in the nano-scale, e.g., up to about 50 nm or so, at a relatively low concentration, up to about 100 ppm in a liquid suspension. Sizes and concentrations above these levels can be used as well in some instances, provided issues related to bioaccumulation can be addressed. In some examples, Ag404 colloidal silver from American Biotech Labs has been shown effective for oral delivery, with an average particle size from about 5 nm to about 15 nm in size. The bioactivity of Ag404 in particular may be related at least in part to its surface area to volume ratio due to its considerably small size, without substantial bioaccumulation. Whether this colloidal silver is used or another, a benefit to using colloidal silver can relate to its ability to steal electrons from pathogens and reduce the bio load of various pathogens in the body.

### Methylated Vitamin B12 (Methylcobalamin)

Regarding the methylated vitamin B12 that can be included in some of the various nutritional supplement compositions described herein, it is noted that the methylated form of the B12 vitamin represents a form that is usable by the human body with little to no conversion within the body. In other words, when administered in this form, the body receives a form of the B12 vitamin that is ready for use without the need to convert the B12 vitamin from a different form to the methylated form. There is a significant portion of the population that has difficulty within the body converting vitamin B12 to the methylated form, and thus, may not benefit from even high doses of vitamin B12. In the methylated form, starting with a compound that is similar to that which the body can use to assist with various metabolic processes can be advantageous, particularly when administered at a relatively low concentration with other compounds that may be present. For example, methylated vitamin B12 can be more bioavailable and useful when dosed appropriately, particularly with some subjects with gene mutations rendering their body inefficient for in situ methylation, e.g., subjects with the MTHFR gene mutation. Other benefits of administering methylated vitamin B12 includes enhanced tissue retention (compared to the more toxic cyanocobalamin), support for neurological activity, reduced homocysteine levels, enhanced brain health/mood regulation and cardiovascular health, and/or better uptake for treating B12 deficiency.

In some examples, there may be additional benefits of administering additional B-complex vitamins, such as vitamin B6 (pyridoxine), which in some examples, can be in the form of pyridoxal 5′ phosphate (PLP). PLP is the active form of vitamin B6 and is a coenzyme for a variety of enzymatic activities, including as a significant coenzyme in transamination reactions, as well as a coenzyme in some decarboxylation, deamination, and racemization reactions of amino acids.

### Vitamin C

Vitamin C, which can be in the form of ascorbic acid and/or an ascorbate, is a water-soluble vitamin that is found in many fruits, and is considered an essential nutrient involved in tissue repair, formation of collagen, and the enzymatic production of some neurotransmitters as part of the central nervous systems. Vitamin C is also used for the functioning of several enzymes associated with the immune system. The structure of vitamin C (as ascorbic acid) is shown in Formula I, as follows:

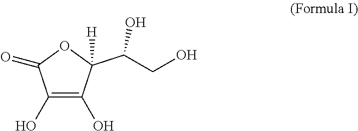 [SMILES: O=C1O[C@@H]([C@H](O)CO)C(O)=C1O]

In accordance with examples herein, vitamin C can be particularly useful when combined with methylthioninium chloride in treating disorders and diseases associated with dementia due to its enzymatic activity related to neurotransmitters. For example, vitamin C is a potent antioxidant that can help protect mitochondria from oxidative stress. Mitochondria are particularly vulnerable to oxidative damage due to the high levels of reactive oxygen species (ROS) they generate during energy production. By scavenging ROS, vitamin C helps prevent damage to mitochondrial DNA, proteins, and lipids, thus supporting their function and overall health. As methylthioninium chloride also interacts with mitochondria, e.g., it can act as an electron carrier to help with ATP production, and can work well when combined with vitamin C. When used together, vitamin C and methylthioninium chloride can provide complimentary or even synergistic effects on mitochondria health. For example, both compounds have antioxidant properties, so when used together, they may provide enhanced protection against oxidative damage to mitochondria.

### Nicotinamide Adenine Dinucleotide (NAD)

In accordance with examples of the present disclosure, nicotinamide adenine dinucleotide (NADH or NAD+) can be administered as part of any of the nutritional supplement compositions of the present disclosure, and can act as a coenzyme that supports many of the body's biological processes. For example, NAD+ can assist with protecting cells from stress, supporting healthier sleep cycles, and participating in the repair of damaged DNA. Natural levels of NAD+ decline as subjects begin to age, so supplementation of nicotinamide adenine dinucleotide can assist with improving biological functions associated with these and other conditions as you get older. An example structure of nicotinamide adenine dinucleotide (NAD+) is shown in Formula II, as follows:

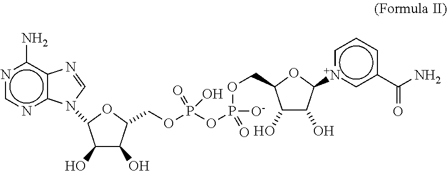

Formulations including nicotinamide adenine dinucleotide, which is a tertiary compound, can assist with enhancing mitochondrial health and function, particularly when formulated with a mitochondria-enhancing compound(s), such as pyrroloquinoline quinone (as described in greater detail hereinafter). Nicotinamide adenine dinucleotide is a versatile compound when present within the body of a subject, and thus, can also provide other benefits, such as cognitive and/or other metabolic benefits. For example, nicotinamide adenine dinucleotide can provide the raw materials for establishing a pathway for methylthioninium salts to receive electrons from nicotinamide adenine dinucleotide. In some examples when pyrroloquinoline quinone is administered with nicotinamide adenine dinucleotide, it can assist with producing energy suitable for brain function, as the ATP production can be enhanced after passing through the blood-brain barrier.

As mentioned, the nicotinamide adenine dinucleotide can include both NAD+ and/or NADH. However, in some examples, the compound can be in the form of at least about 99 wt % NAD+, at least about 99.5 NAD+, or at least about 99.7 wt % NAD+. By providing the nicotinamide adenine dinucleotide at a very high weight ratio of NAD+ to NADH, e.g., from 99:1 or greater, from 99.5:0.5 or greater, or from 99.7:0.3 or greater, these compositions are in their more active and usable form, which can bypass any needed conversion step in the body.

Regarding the daily dosage(s) of nicotinamide adenine dinucleotide in combination with from about 5 mg to about 25 mg of pyrroloquinoline quinone, it can be co-administered in a formulation including from about 50 mg to about 200 mg nicotinamide adenine dinucleotide. Other amounts or weight ratios of nicotinamide adenine dinucleotide with other nutritional supplement compositions as described herein can likewise be selected for use, e.g., from about 20 mg to about 250 mg, from about 20 mg to about 120 mg, from about 20 mg to about 100 mg, from about 30 mg to about 100 mg, or from about 40 mg to about 100 mg.

### Pyrroloquinoline Quinone (PQQ)

Pyrroloquinoline quinone is a compound that is related to the B-vitamin family, which provides strong antioxidant support for mitochondria and can support cellular energy and assist with maintaining a healthy mind, including supporting a healthy memory. For example, pyrroloquinoline quinone can enhance or support mitochondrial general health as well as growth, and furthermore is neuroprotective against mental function that may be lost due to aging or other conditions. In addition to being effective for mitochondrial health as it relates to mental function, it can also support muscle and other tissue maintenance and growth. Regarding its antioxidant properties, pyrroloquinoline quinone has been reported as being more than two orders of magnitude (>100×) more effective at triggering continuous cycling compared to more common antioxidants, such as vitamin C and various phenolic compounds. In other words, pyrroloquinoline quinone can cycle back between multiple forms, including between a first active form and a second antioxidant form. Cycling back and forth between these two forms, depending on conditions, can provide the ability for performing antioxidant functions as it cycles back and forth for repeated oxidation and reduction reactions. This cycling for repeated antioxidant use provides an excellent way of supporting the central nervous system, e.g., brain, spinal cord, and other nervous system cells or tissue.

The structure of pyrroloquinoline quinone is shown by way of example in Formula III, as follows:

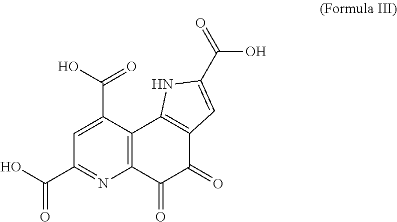 [SMILES: O=C(O)c1cc(C(=O)O)c2c(n1)C(=O)C(=O)c1cc(C(=O)O)[nH]c1-2]

As mentioned, pyrroloquinoline quinone can be formulated in a nutritional supplement composition with nicotinamide adenine dinucleotide, e.g., about 50 mg to about 200 mg NAD and about 5 mg to about 25 mg PQQ. In other examples, pyrroloquinoline quinone can be formulated as part of a nutritional supplement composition with a methylthioninium salt, e.g., methylthioninium chloride (methylene blue) and urolithin A. In some examples, this nutritional supplement composition can also include methylated vitamin B12. When formulated with methylene blue, for example, this combination can provide a potent antioxidant that supports mitochondrial biogenesis and function. Furthermore, pyrroloquinoline quinone can enhance nicotinamide adenine dinucleotide (NAD) production and use, assisting with mitochondrial efficiency. In further detail, pyrroloquinoline quinone can enhance the housekeeping of the cell with its function supporting mitochondrial mitophagy while the methylthioninium salt can enhance ATP production. As ATP is the source of cellular energy storage and delivery produced by the mitochondria, health implications as it relates to the heart, brain, muscles, and other major organs can benefit greatly from the presence of pyrroloquinoline quinone, particularly when there is some dysfunction, such as the slowing of this functionality as a result of aging. The presence of pyrroloquinoline quinone can assist with supporting the appropriate structure and/or function of the mitochondria. In still further detail, by including methylated vitamin B12 in the composition, the benefits associated therewith can likewise be achieved, including providing B12 to subjects suffering from certain gene mutations inhibiting conversion of other forms of B12 to the more usable methylated vitamin B12 compound, enhancing tissue retention (compared to the more toxic cyanocobalamin), supporting neurological activity, reducing homocysteine levels, enhancing brain health/mood regulation and cardiovascular health, and/or providing better uptake for treating B12 deficiency. It is noted that various weight percentages and weight ratios of pyrroloquinoline quinone with other compounds in various nutritional supplement compositions is described elsewhere herein.

### Urolithin A

Urolithin A is a postbiotic compound that is instrumental in triggering mitophagy, which is a specific type or autophagy related to cellular recycling. More specifically, urolithin A is a benzo-coumarin (or dibenzo-α-pyrones) compound and is a metabolite of ellagitannin precursors, which can be transformed to urolithin A by certain gut bacteria. In addition to the ellagitannin precursors, Urolithin A has other precursors, such as ellagic acids. More specifically, ellagitannins can be hydrolyzed in the gut to release ellagic acid, which can be further processed by the gut microflora into urolithin A, e.g., via removal of lactone and hydroxyl groups. These precursors are prevalent in various foods and editable plants, such as nuts, e.g., walnuts, pomegranates, berries, e.g., strawberries, raspberries, blackberries, cloudberries, etc., teas, muscadine grapes, and many others.

Even though the precursors are found in natural foods and can be consumed readily, the metabolite urolithin A is not found typically in food sources per se. Furthermore, there are some humans in particular that do not efficiently convert ellagitannins into urolithin A, and other humans may not convert ellagitannins into urolithin A at all. For example, the transformation of ellagic acids into urolithin A depends greatly on the microflora composition in the gut of the subject, which can vary significantly. As fewer and fewer natural foods are being consumed in recent years, the microflora composition of the gut of many individuals may not be optimally established for this transformation. A change in diet may provide an improved microbiome, but genetics may also play a role in the body's ability to make this transformation from precursors to achieving blood serum levels of urolithin A that would be effective in promoting overall mitochondrial health via a healthy level of mitophagy.

In further detail, as subjects, e.g., humans, age, they become more and more exposed to various environmental toxins and/or stresses, e.g., EMF, chemical, psychological stress, and mitochondrial function tends to decline, leading to increases in chronic disease (due to progressive failure of the mitochondria). In addition to chronic disease, these factors can also lead to reduced energy, slower metabolism, cognitive decline, etc. Repair of the mitochondria, e.g., with mitochondrial DNA damage, such as by processes related to identification of poor cellular function can occur, and when repair is warranted, mitophagy or autophagy may be initiated via cellular reduction along with cellular replacement. With these factors and others negatively impacting the mitochondria, it has been found that urolithin A can: i) stimulate the renewal of mitochondria by encouraging replacement of damaged or dysfunctional mitochondria with higher functioning mitochondria; ii) stimulate anti-inflammatory properties and assist with the reducing of inflammation markers associated with chronic disease often exacerbated by inflammation; iii) provide a potent antioxidant to protect cells from damage caused by free radicals; iv) improve muscle strength, growth, and muscle repair (at a cellular level) by influencing health markers and muscle genes associated with mitochondria present in the muscle tissue; and v) positively impact gut health by altering the gut microbiota, improving alpha diversity, restoring colonic barrier function, etc.

In accordance with this, it is believed that less than about 40%-50% of humans can effectively generate urolithin A from its precursors in situ. Thus, for such individuals, supplementation of urolithin A can be highly beneficial with respect to the mitochondria at a cellular level, particularly when formulated with certain compounds of the nutritional supplement compositions of the present disclosure, e.g., a methylthioninium salt, pyrroloquinoline quinone, nicotinamide adenine dinucleotide, etc.

To provide one example of the benefits of urolithin on mitochondrial health, the health of muscle tissue can be considered. In accordance with this, the administration of urolithin A can be particularly useful in middle-aged and elderly individuals for muscle health, and furthermore, is sufficiently bioavailable and well tolerated as an oral supplement. Examples of the benefits urolithin A has on muscle tissue include the maintaining or enhancing of muscle endurance, strength, exercise performance, biomarkers of mitochondrial health, and/or overall muscle health. Furthermore, urolithin A can also lower levels of plasma acylcarnitine compounds and C-reactive proteins, which provides evidence for enhanced mitochondrial efficiency and reduced inflammation.

Urolithin A can enter systemic circulation via absorption through the intestines, making it an acceptable compound for oral delivery when dosed at appropriate levels. Urolithin A, as an intact molecule, is shown in Formula IV below.

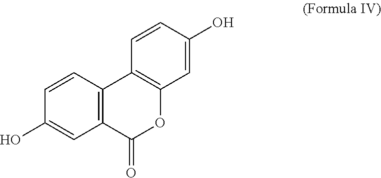 [SMILES: O=c1oc2cc(O)ccc2c2ccc(O)cc12]

Furthermore, when urolithin A is within the body, e.g., the gut, intestinal absorption cells (or enterocytes), systemic circulation, tissue, organs, (hepatocytes such as in the liver), etc., various types of compound transformations may occur in situ, e.g., glucuronidation, methylation, sulfation, etc. As a result, urolithin A has various derivatives, including urolithin A glucuronide, urolithin A sulfate, etc., which can be present in systemic circulation prior to being excreted via the urine. In accordance with this, reference to “urolithin A” herein includes the form of urolithin A shown at Formula IV, as well as its salts and derivatives that may be beneficial within the body. Typically, urolithin A as shown in Formula IV is delivered orally as described herein, but could be delivered as a salt or as a derivative in some instances. It is noted that various weight percentages and weight ratios of urolithin A with other compounds in various nutritional supplement compositions is described elsewhere herein.

### Methylthioninium Salt, e.g., Methylthioninium Chloride (Methylene Blue)

Methylthioninium salts, such as methylthioninium chloride (or methylene blue), are synthetic chemical compounds with a crystalline structure. For example, methylthioninium chloride has a specific crystalline structure appearing dark green as a powder at room temperature and blue when mixed in water. The blue color can be lost with time when at rest, e.g., in its reduced state due to lack of interaction with oxygen), but re-emerges as blue when agitated, e.g., in its oxidized state. Because of these unique properties, it has been used diagnostically to distinguish tissues and fluids in a lab setting. Methylthioninium salts can also function similar to hemoglobin, the substance responsible for transporting oxygen to the body's tissues and organs, making it a good candidate for various therapies, though its use orally over the years has led to different levels of success. In further detail, methylthioninium chloride is a formal derivative of phenothiazine, with the hydrated form having three (3) molecules of water per single molecule of the methylthioninium chloride compound. The structure of methylthioninium chloride is shown by way of example in Formula V, as follows:

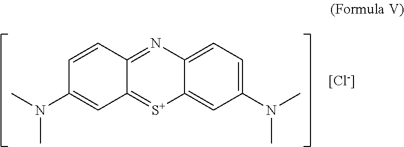

In accordance with the present disclosure, when a methylthioninium salt, such as methylthioninium chloride, is co-formulated with other compounds, such as other mitochondria-enhancing compound, the impact the combination can have on mitochondrial function and health can be enhanced, particularly when the methylthioninium chloride is given orally at a relatively low dose. In some instances, multiple compounds co-administered or co-formulated together can exhibit synergy in treating various conditions, including any of a number of cognitive and/or neurological conditions.

It is generally understood that mitochondria are the energy producers of the cells, and often neurodegenerative and psychiatric disorders can lead to mitochondrial damage. The neuroprotective properties of methylthioninium salts can, for example, improve mitochondrial function such that a subject may see improvements in memory retention, cytochrome oxidase activity, ATP generation, etc., thus assisting with the maintenance of neural health and cognitive function. Furthermore, mitochondrial disfunctions can decrease energy transfer to the cells resulting in cellular damage and/or death, e.g., cellular damage can increase neuroinflammation. Furthermore, when mitochondria disfunctions, energy transfers may cease to occur, leading to cellular death. Additionally, toxic build up can occur, leading to oxidative stress and the release of free radicals (and ultimately, loss of neurons).

In further detail, methylthioninium salt, particularly when dosed with the mitochondria-enhancing compound that impacts the mitochondria, can act to enhance not only the function of mitochondria, but can act to repair mitochondrial damage and/or provide conditions for mitophagy to occur to degrade damaged mitochondria by autophagy. Examples of mitochondria-enhancing compounds that may provide a secondary mitochondrial benefit include urolithin A, pyrroloquinoline quinone, methylated vitamin B12, etc. Furthermore, methylthioninium salt can provide benefits as a superoxide (antioxidant) to reduce or eliminate free radicals that assist in repairing impairments in mitochondrial function and cellular metabolism. In connection with this, by improving mitochondrial function and reducing oxidative damage, methylthioninium salt can contribute to anti-aging in some subjects. For example, methylthioninium salt can bypass Complex I/III activity in the mitochondria, reducing oxidative stress and improving mitochondrial efficiency, which can be beneficial for treating age-related conditions, such as neurodegeneration, memory loss, skin aging, and the like.

In accordance with examples of the present disclosure, the nutritional supplement compositions that include a methylthioninium salt, e.g,. methylthioninium chloride, are considered hormetic substances, meaning that it is most effective at lower dosages, and in fact, may be counterproductive if dosed at too high of a level. In accordance with this, the methylthioninium chloride can be present in a single dose (or total daily dose) of one or more of the nutritional supplement compositions at from about 1 mg to about 50 mg, from about 1 mg to about 25 mg, from about 1 mg to about 20 mg, from about 1 mg to about 15 mg, from about 1 mg to about 12 mg, from about 2 mg to about 20 mg, from about 2 mg to about 15 mg, from about 2 mg to about 12 mg, or from about 2 mg to about 10 mg. These daily dosages (taken at one time or as divided daily dosages) or single dosage form, e.g., single table, capsule, etc., at the ranges recited above can be used in any of the combination therapies or treatments described by way of example herein, irrespective of the narrower ranges provided for the methylthioninium salt that may be recited hereinafter in the context of more specific examples. Regarding the ratio of the methylthioninium salt to the other compounds for coadministration or in forming the nutritional supplement compositions, it may depend on the other compound(s) present, as illustrated by example in greater detail hereinafter.

Methylthioninium salts can also provide some alternative energy transfer that is effective for protecting neurons by increasing ATP production (which provides energy for the brain via mitochondria respiration). More specifically, as there is a link between methylthioninium salt and neurodegenerative disorders and/or energy metabolism, oral delivery of methylthioninium salt can result in electrons being received from nicotinamide adenine dinucleotide (NADH and/or NAD+) in the presence of Complex I and donate them to Cytochrome C, thus providing an alternative electron transfer pathway. This can result in an increase in oxygen consumption, a decrease in glycolysis, and an increase in glucose uptake enhancing cerebral blood flow. This can be particularly useful for therapeutic uses that increase ATP production after passing through the blood-brain barrier. In accordance with this, in some examples, the compositions of the present disclosure including the methylthioninium salt and the second mitochondria-enhancing compound can be co-formulated or co-administered with nicotinamide adenine dinucleotide, the benefits of which are provided in greater detail hereinafter.

### GLP-1 Agonists

In accordance with examples of the present disclosure, the various supplement compositions (including the liquid mineral supplement compositions) can be co-administered with a glucagon-like peptide-1 (GLP-1) medication (or “GLP-1 agonist), such as dulaglutide, exenatide, liraglutide, lixisenatide, semaglutide, tirzepatide, or the like. Notably, semaglutide and OZEMPIC are essentially the same drug, with slight variations in formulations or dosages based on healthcare provider recommendations. For example, OZEMPIC is essentially the brand name for semaglutide used for diabetes management and may have slightly greater reduction in HbA1c levels when administered, whereas semaglutide can be compounded and is not FDA-approved. With that stated, for purposes of the present disclosure, semaglutide and OZEMPIC are considered synonymous with the understanding that minimal variations can occur as a result of the manufacturing and/or compounding process. In further detail, GLP-1 agonists can be used to treat diabetes or subjects that may be pre-diabetic and/or overweight by stimulating the release of insulin and/or lower blood sugar levels. By combining a GLP-1 agonist with any of the various nutritional supplement compositions described herein, a powerful tool for weight loss and long-term weight management, along with some enhanced energy and even mood elevation can be achieved. Furthermore, GLP-1 co-administered with the nutritional supplement compositions as described herein can have additional benefits in some instances, such as improved insulin sensitivity, enhanced mitochondria health, enhanced metabolic ignition, enhanced calorie burning, etc.

### EXAMPLE EMBODIMENTS

In accordance with the disclosure herein, the following examples are illustrative of several embodiments of the present technology.
1. A liquid nutritional supplement composition, comprising:
from about 85 wt % to about 98 wt % liquid carrier (or water)
from about 0.5 wt % to about 5 wt % mineral blend, wherein the mineral blend includes sodium, calcium, magnesium, potassium, and silicon each being independently present in the form of a mineral salt, a mineral oxide, or a mineral chloride; and
from about 0.25 wt % to about 3 wt % methylated vitamin B12, from about 0.25 wt % to about 3 wt % vitamin C, or both.
2. The liquid nutritional supplement composition of example 1, wherein the methylated vitamin B12 and the vitamin C are both present in the liquid nutritional supplement composition.
3. The liquid nutritional supplement composition of example 2, wherein a single dose of the liquid nutritional supplement composition is from about 0.5 mL to about 4.5 mL in volume, and the single dose includes:
from about 10 mg to about 75 mg of the mineral blend;
from about 1 mg to about 20 mg of the methylated vitamin B12; and
from about 5 mg to about 20 mg of the vitamin C.
4. The liquid nutritional supplement composition of one of examples 1 to 3, wherein the mineral blend is present in the liquid nutritional supplement composition at from about 0.5 vol % to about 3 vol %.
5. The liquid nutritional supplement composition of one of examples 1 to 4, further comprising hydrogen peroxide formed in situ.
6. The liquid nutritional supplement composition of one of examples 1 to 5, wherein the mineral blend includes at least about 50 wt % mineral salt, mineral oxide, or mineral chloride in the form of magnesium salt, magnesium oxide, magnesium chloride, or a combination thereof based on a total weight of the mineral blend.
7. The liquid nutritional supplement composition of one of examples 1 to 6, further comprising a GLP-1 agonist.
8. The liquid nutritional supplement composition of one of examples 1 to 7, further comprising colloidal silver, black pepper, vitamin B6, vitamin E, manganese, a cannabinoid, nicotine, caffeine, L-theanine, or a combination thereof.
9. The liquid nutritional supplement composition of one of examples 1 to 8, further comprising nicotinamide adenine dinucleotide in the form of NADH, NAD+, or a combination thereof.
10. The liquid nutritional supplement composition of one of examples 1 to 9, wherein the nicotinamide adenine dinucleotide is present at a NAD+ to NADH weight ratio of at least about 99:1.
11. A method of enhancing a biological function in a subject, comprising: orally administering the liquid nutritional supplement composition of one of examples 1 to 10 to a subject.
12. The method of example 11, further comprising orally co-administering the liquid nutritional supplement composition with a GLP-1 agonist co-formulated as part of the liquid nutritional supplement composition, or as a separate dosage form at the same time as the liquid nutritional supplement composition or at a different time during a single day relative the liquid nutritional supplement composition.
13. the method of example 12, wherein the GLP-1 agonist includes dulaglutide, exenatide, liraglutide, lixisenatide, semaglutide, tirzepatide, or a combination thereof.
14. the method of example 12, wherein the GLP-1 agonist includes semaglutide.
15. The method of one of examples 12 to 14, wherein the subject is orally administered the liquid nutritional supplement composition and the GLP-1 agonist for promoting weight loss, providing long-term weight management, or both.
16. The method of one of examples 11 to 15, further comprising orally co-administering from about 10 mg to about 200 mg nicotinamide adenine dinucleotide in the form of NADH, NAD+, or a combination thereof to the subject on a daily basis.
17. The method of example 16, wherein the nicotinamide adenine dinucleotide is present at a NAD+ to NADH weight ratio of at least about 99:1.
18. The method of one of examples 11 to 17, wherein the subject is orally administered the liquid nutritional supplement composition for promoting mitochondrial health, cellular health, weight loss, long-term weight management, cardiovascular health, brain health and function, or a combination thereof.
19. The method of one of examples 11 to 18, further comprising orally co-administering a second nutritional supplement composition to the subject at the same time or at different times during a single day, wherein the second nutritional supplement composition includes:
nicotinamide adenine dinucleotide in the form of NADH, NAD+, or a combination thereof; and
pyrroloquinoline quinone,
wherein the nicotinamide adenine dinucleotide and the pyrroloquinoline quinone are present in the nutritional supplement composition at a weight ratio from about 1:40 to about 1:2.
20. The method of one of examples 11 to 19, further comprising orally co-administering a second nutritional supplement composition to the subject at the same time or at different times during a single day, wherein the second nutritional supplement composition includes:
a methylthioninium salt;
urolithin A; and
pyrroloquinoline quinone,
wherein the methylthioninium salt to urolithin A weight ratio is from about 1:600 to about 1:4 and the methylthioninium salt to pyrroloquinoline quinone weight ratio is from about 1:20 about 50:1.
21. A nutritional supplement composition, comprising:
nicotinamide adenine dinucleotide in the form of NADH, NAD+, or a combination thereof; and
pyrroloquinoline quinone,
wherein the nicotinamide adenine dinucleotide and the pyrroloquinoline quinone are present in the nutritional supplement composition at a weight ratio from about 1:40 to about 1:2.
22. The nutritional supplement composition of example 21, wherein the nicotinamide adenine dinucleotide is present at a NAD+ to NADH weight ratio of at least about 99:1.
23. The nutritional supplement composition of one of examples 21 to 22, wherein the nicotinamide adenine dinucleotide is present at a NAD+ to NADH weight ratio of at least about 99.5:0.5.
24. The nutritional supplement composition of one of examples 21 to 23, wherein a single dose of the nutritional supplement composition includes from about 50 mg to about 200 mg of the nicotinamide adenine dinucleotide and from about 5 mg to about 25 mg of the pyrroloquinoline quinone.
25. The nutritional supplement composition of one of examples example 22 to 24, further comprising a GLP-1 agonist.
26. The nutritional supplement composition of one of examples example 22 to 24, wherein the single dose is in the form of a single tablet or capsule or in the form of multiple tablets or capsules.
27. The nutritional supplement composition of one of examples 21 to 26, wherein the nutritional supplement composition incudes an excipient blend of microcrystalline cellulose, magnesium stearate, silicon dioxide, and dicalcium phosphate.
28. The nutritional supplement composition of one of examples 21 to 27, further comprising urolithin A.
29. The nutritional supplement composition of example 28, wherein the pyrroloquinoline quinone and the urolithin A are present in the nutritional supplement composition at a weight ratio from about 1:100 to about 1:2.
30. The nutritional supplement composition of one of examples 21 to 29, wherein the pyrroloquinoline quinone is present at sufficient concentration to enhance conversion of NADH to NAD+.
31. A method of enhancing a biological function in a subject, comprising: orally administering the nutritional supplement composition of one of examples 21 to 30 to a subject.
32. The method of example 31, further comprising orally co-administering the nutritional supplement composition with a GLP-1 agonist co-formulated as part of the nutritional supplement composition, or as a separate dosage form at the same time as the nutritional supplement composition or at a different time during a single day relative the nutritional supplement composition.
33. The method of example 32, wherein the GLP-1 agonist includes dulaglutide, exenatide, liraglutide, lixisenatide, semaglutide, tirzepatide, or a combination thereof.
34. The method of example 32, wherein the GLP-1 agonist includes semaglutide.
35. The method of one of examples 32 to 34, wherein the subject is orally administered the nutritional supplement composition and the GLP-1 agonist for promoting weight loss, providing long-term weight management, or both.
36. The method of one of examples 31 to 35, further comprising orally co-administering a liquid nutritional supplement composition to the subject at the same time or at different times during a single day, wherein the liquid nutritional supplement composition includes:
an aqueous liquid carrier;
from about 0.5 wt % to about 5 wt % of a mineral blend, wherein the mineral blend includes sodium, calcium, magnesium, potassium, and silicon each being independently present in the form of a mineral salt, a mineral oxide, or a mineral chloride; and
methylated vitamin B12, vitamin C, or both,
wherein a single dose from about 0.5 mL to about 2.5 mL of the liquid nutritional supplement composition includes from about 1 mg to about 20 mg of the methylated vitamin B12 when present and from about 5 mg to about 20 mg of the vitamin C when present.
37. The method of one of examples 31 to 36, further comprising orally co-administering a second nutritional supplement composition to the subject at the same time or at different times during a single day, wherein the second nutritional supplement composition includes:
a methylthioninium salt;
urolithin A; and
pyrroloquinoline quinone,
wherein the methylthioninium salt to urolithin A weight ratio is from about 1:600 to about 1:4 and the methylthioninium salt to pyrroloquinoline quinone weight ratio is from about 1:20 about 50:1.
38. The method of example 37, wherein the second nutritional supplement also includes a methylated vitamin B12 at a methylthioninium salt to methylated vitamin B12 weight ratio of about 1:20 to about 50:1.
39. The method of one of examples 31 to 38, wherein the nicotinamide adenine dinucleotide is present at a NAD+ to NADH weight ratio of at least about 99:1.
40. The method of one of examples 31 to 39, wherein the subject is orally administered the nutritional supplement composition for enhancing mitochondrial function, biogenesis, NAD+ production and utilization, cellular metabolism, energy production, antioxidant defense, energy brain health and function, cellular function, or a combination thereof.
41. A nutritional supplement composition, comprising:
a methylthioninium salt;
urolithin A;
pyrroloquinoline quinone; and
methylated vitamin B12, nicotinamide adenine dinucleotide in the form of NADH, NAD+, or a combination thereof, or both,
wherein the nutritional supplement composition has a methylthioninium salt to urolithin A weight ratio from about 1:600 to about 1:4, a methylthioninium salt to pyrroloquinoline quinone weight ratio from about 1:20 to about 50:1, a methylthioninium salt to methylated vitamin B12 weight ratio from about 1:20 to about 50:1 if present, and a methylthioninium salt to nicotinamide adenine dinucleotide weight ratio from about 2:5 to about 200:1 if present.
42. The nutritional supplement composition of example 41, wherein a single oral dosage form includes:
from about 1 mg to about 25 mg of the methylthioninium salt; and
from about 100 mg to about 600 mg of urolithin A,
from about 0.5 mg to about 20 mg of the pyrroloquinoline quinone, and
from about 0.5 mg to about 20 mg methylated vitamin B12.
43. The nutritional supplement composition of example 42, further comprising from about 10 mg to about 200 mg of the nicotinamide adenine dinucleotide.
44. The nutritional supplement composition of one of examples 41 to 43, wherein a single oral dosage form includes:
from about 1 mg to about 25 mg of the methylthioninium salt; and
from about 100 mg to about 600 mg of urolithin A,
from about 0.5 mg to about 20 mg of the pyrroloquinoline quinone, and
from about 10 mg to about 200 mg nicotinamide adenine dinucleotide.
45. The nutritional supplement composition of one of examples 41 to 44, wherein the nicotinamide adenine dinucleotide is present and included at a NAD+ to NADH weight ratio of at least about 99:1.
46. The nutritional supplement composition of one of examples 41 to 45, further comprising a GLP-1 agonist.
47. The nutritional supplement composition of one of examples 41 to 46, wherein the single dose is in the form of a single tablet or capsule or in the form of multiple tablets or capsules.
48. The nutritional supplement composition of one of examples 41 to 47, wherein the nutritional supplement composition incudes an excipient blend of microcrystalline cellulose, magnesium stearate, silicon dioxide, and dicalcium phosphate.
49. The nutritional supplement composition of one of examples 41 to 48, wherein the methylthioninium salt and the pyrroloquinoline quinone are present at a weight ratio from about 1:20 to about 30:1, and wherein the urolithin A and the pyrroloquinoline quinone are present at a urolithin A to pyrroloquinoline quinone weight ratio from about 5:1 to about 1200:1.
50. The nutritional supplement composition of one of examples 41 to 49, wherein the methylthioninium salt is in the form of methylthioninium chloride.
51. A method of enhancing a biological function in a subject, comprising: orally administering the nutritional supplement composition of one of examples 41 to 50 to a subject.
52. The method of example 51, wherein the nicotinamide adenine dinucleotide is present in the nutritional supplement composition and included at a NAD+ to NADH weight ratio of at least about 99:1.
53. The method of one of examples 51 to 52, further comprising orally co-administering the nutritional supplement composition with a GLP-1 agonist co-formulated as part of the nutritional supplement composition, or as a separate dosage form at the same time as the nutritional supplement composition or at a different time during a single day relative the nutritional supplement composition.
54. The method of example 53, wherein the GLP-1 agonist includes dulaglutide, exenatide, liraglutide, lixisenatide, semaglutide, tirzepatide, or a combination thereof.
55. The method of example 53, wherein the GLP-1 agonist includes semaglutide.
56. The method of one of examples 52 to 55, wherein the subject is orally administered the nutritional supplement composition and the GLP-1 agonist for promoting weight loss, providing long-term weight management, or both.
57. The method of one of examples 51 to 56, further comprising orally co-administering a liquid nutritional supplement composition to the subject at the same time or at different times during a single day, wherein the liquid nutritional supplement composition includes:
an aqueous liquid carrier;
from about 0.5 wt % to about 5 wt % of a mineral blend, wherein the mineral blend includes sodium, calcium, magnesium, potassium, and silicon each being independently present in the form of a mineral salt, a mineral oxide, or a mineral chloride; and
methylated vitamin B12, vitamin C, or both,
wherein a single dose from about 0.5 mL to about 2.5 mL of the liquid nutritional supplement composition includes from about 1 mg to about 20 mg of the methylated vitamin B12 when present and from about 5 mg to about 20 mg of the vitamin C when present.
58. The method of one of examples 51 to 57, wherein the subject is orally administered the nutritional supplement composition for enhancing mitochondrial health, supporting weight loss, long-term management, enhance nicotinamide adenine dinucleotide production, enhance mitochondrial mitophagy, or a combination thereof.
59. The method of one of examples 51 to 58, wherein the nutritional supplement composition is dosed on a daily basis with sufficient methylthioninium salt to stimulate ATP production and sufficient pyrroloquinoline quinone to enhance nicotinamide adenine dinucleotide production, mitochondrial mitophagy, or a combination thereof.
60. The method of one of examples 51 to 59, wherein the nicotinamide adenine nucleotide is not included in the nutritional supplement composition, but the adenine nucleotide is co-administered at from about 10 mg to about 200 mg together or on the same day as the nutritional supplement composition.
61. A method of enhancing weight loss or supporting long-term weight management, comprising:
orally co-administering a GLP-1 agonist; and
a nutritional supplement composition including:
   a methylthioninium salt,
   urolithin A, and
   pyrroloquinoline quinone, and
   wherein the nutritional supplement composition has a methylthioninium salt to urolithin A weight ratio from about 1:600 to about 1:4, and a methylthioninium salt to pyrroloquinoline quinone weight ratio from about 1:20 to about 50:1.
62. The method of example 61, wherein the GLP-1 agonist is co-formulated as part of the nutritional supplement composition.
63. The method of one of examples 61 to 62, wherein the GLP-1 agonist is a separate dosage form that is co-administered at the same time as the nutritional supplement composition or at a different time during a single day relative the nutritional supplement composition.
64. The method of one of examples 61 to 63, wherein the nutritional supplement composition further includes a methylated vitamin B12 at a methylthioninium salt to methylated vitamin B12 weight ratio from about 1:20 to about 50:1.
65. The method of one of examples 61 to 64, wherein a single oral dosage form includes:
from about 1 mg to about 25 mg of the methylthioninium salt; and
from about 100 mg to about 600 mg of urolithin A, and
from about 0.5 mg to about 20 mg of the pyrroloquinoline quinone,
66. The method of example 65, wherein the nutritional supplement composition further includes a methylated vitamin B12 and the single oral dosage form includes from about 0.5 mg to about 20 mg methylated vitamin B12.
67. The method of one of examples 61 to 66, wherein the nutritional supplement composition incudes an excipient blend of microcrystalline cellulose, magnesium stearate, silicon dioxide, and dicalcium phosphate.
68. A combination therapy, comprising co-administering two or more nutritional supplement compositions within a single day to a subject, the two or more nutritional supplement compositions including:
a first nutritional supplement composition including:
   from about 85 wt % to about 98 wt % liquid carrier, from about 0.5 wt % to about 5 wt % of a mineral blend, from about 0.25 wt % to about 3 wt % methylated vitamin B12, and from about 0.25 wt % to about 3 wt % vitamin C, wherein the mineral blend includes sodium, calcium, magnesium, potassium, and silicon each being independently present in the form of a mineral salt, a mineral oxide, or a mineral chloride;
a second nutritional supplement composition including:
   nicotinamide adenine dinucleotide in the form of NADH, NAD+, or a combination thereof, and
   pyrroloquinoline quinone,
   wherein the second nutritional supplement composition has a nicotinamide adenine dinucleotide to pyrroloquinoline quinone weight ratio from about 1:40 to about 1:2;
a third nutritional supplement composition including:
   a methylthioninium salt,
   urolithin A, and
   pyrroloquinoline quinone,
   wherein the third nutritional supplement composition has a methylthioninium salt to urolithin A weight ratio from about 1:600 to about 1:4 and a methylthioninium salt to pyrroloquinoline quinone weight ratio from about 1:20 to about 50:1;
a fourth nutritional supplement composition, including:
   a methylthioninium salt,
   caffeine, and
   L-theanine,
   wherein the fourth nutritional supplement composition has a methylthioninium chloride to the caffeine weight ratio from about 1:75 to about 1:4, a methylthioninium chloride to the L-theanine weight ratio from about 1:200 to about 1:10, and a caffeine to the L-theanine weight ratio from about 1:5 to about 1:1.
69. The combination therapy of example 68, wherein the third nutritional supplement composition further includes a methylated vitamin B12 having a methylthioninium salt to methylated vitamin B12 weight ratio from about 1:20 to about 50:1.
70. The combination therapy of one of examples 68 to 69, wherein the caffeine of the fourth nutritional supplement composition is provided, at least in part by guarana, green tea, or a combination thereof.
71. The combination therapy of one of examples 66 to 68, further comprising co-administering a GLP-1 agonist within the single day to the subject as a co-formulated dosage with one or more of the first, second, third, or fourth nutritional supplement composition, or as a separate dosage form.

### Definitions

In describing and claiming the present technology, the following terminology will be used.

The singular forms “a,” “an,” and “the” include plural references unless the context clearly dictates otherwise. Thus, for example, reference to “an additive” includes reference to one or more of such components, “a suspension” includes reference to one or more of such suspensions, and “the mixing” refers to one or more of such mixing steps.

As used herein, “substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used herein, “about” refers to a degree of deviation based on experimental error typical for the particular property identified. The latitude provided by the term “about” will depend on the specific context and particular property and can be readily discerned by those skilled in the art. The term “about” is not intended to either expand or limit the degree of equivalents which may otherwise be afforded a particular value. Further, unless otherwise stated, the term “about” expressly includes “exactly,” consistent with the discussion below regarding ranges and numerical data.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the terms “treatment” or “treating” of a condition and/or a disease in a mammal means preventing the condition or disease, that is, avoiding any clinical symptoms of the disease; inhibiting the condition or disease, that is, arresting the development or progression of clinical symptoms; and/or relieving the condition or disease, that is, causing the regression of clinical symptoms and/or healing. In further detail, “treating” can include oral administration of any of the nutritional supplement compositions described herein to heal a subject of a condition or disease, reduce or ameliorate symptoms of a condition or disease, prevent or protect a subject from experiencing or relapsing relative to a condition or disease, causing a condition or disease to regress or retreat, etc.

“Oral” routes of administration include oral ingestion (swallowing) via capsule, tablet, soft-gel, powder, or liquid, e.g., solution or suspension, and/or via transmucosal oral administration, e.g., buccal, sublabial, sublingual, etc. In some instances, some transmucosal oral delivery may occur prior to or after swallowing the bulk of the oral dosage form.

### Examples

The following examples illustrate embodiments of the disclosure that are presently best known. However, it is to be understood that the following are only exemplary or illustrative of the application of the principles of the present technology. Numerous modifications and alternative compositions, methods, and systems may be devised by those skilled in the art without departing from the spirit and scope of the present disclosure. The appended claims are intended to cover such modifications and arrangements. Thus, while the present disclosure has been described herein with particularity, the following examples provide further detail in connection with what are presently deemed to be practical embodiments of the disclosure.

### Example 1—Preparation of Liquid Nutritional Supplement Compositions (NS1)

A liquid nutritional supplement composition (NS1) is prepared by combining a 1:1 weight ratio of methylated vitamin B12 and vitamin C with an aqueous 1.5 vol % mineral blend including sodium, calcium, magnesium, potassium, and silicon. Each of these minerals is independently in the form of a mineral salt, a mineral oxide, or a mineral chloride. The liquid nutritional supplement composition formed is then divided into 30 ml bottles that contains about 28.4 grams of an aqueous liquid vehicle, e.g., water, about 1 gram of the mineral blend, about 0.3 grams of the methylated vitamin B, and about 0.3 grams of the vitamin C. In accordance with this, delivery of about 1 mL as a single dose of NS1 to a subject is sufficient to delivery about 25 mg to about 40 mg of the mineral blend, about 10 mg of the methylated vitamin B12, and about 10 mg of the vitamin C. In accordance with examples of the present disclosure, some hydrogen peroxide may be added or formed in situ, e.g., from about 0.01 wt % to about 0.5 wt %, e.g., about 0.06 wt %.

### Example 2—Preparation of Liquid Nutritional Supplement Compositions (NS2)

A liquid nutritional supplement composition (NS2) is prepared by combining methylated vitamin B12 with an aqueous 1.5 vol % mineral blend including sodium, calcium, magnesium, potassium, and silicon. Each of these minerals is independently in the form of a mineral salt, a mineral oxide, or a mineral chloride. The liquid nutritional supplement composition formed is then divided into 30 mL bottles that contains about 28.55 grams of an aqueous liquid vehicle, e.g., water, about 1 gram of the mineral blend and about 0.45 grams of the methylated vitamin B. In accordance with this, delivery of about 1 mL as a single dose of NS2 to a subject is sufficient to delivery about 25 mg to about 40 mg of the mineral blend, about 15 mg of the methylated vitamin B12. In accordance with examples of the present disclosure, some hydrogen peroxide may be added or formed in situ, e.g., from about 0.01 wt % to about 0.5 wt %, e.g., about 0.06 wt %.

### Example 3—Preparation of Liquid Nutritional Supplement Compositions (NS3)

A liquid nutritional supplement composition (NS3) is prepared by combining vitamin C with an aqueous 1.5 vol % mineral blend including sodium, calcium, magnesium, potassium, and silicon. Each of these minerals is independently in the form of a mineral salt, a mineral oxide, or a mineral chloride. The liquid nutritional supplement composition formed is then divided into 30 ml bottles that contains about 28.55 grams of an aqueous liquid vehicle, e.g., water, about 1 gram of the mineral blend and about 0.45 grams of the vitamin C. In accordance with this, delivery of about 1 mL as a single dose of NS3 to a subject is sufficient to delivery about 25 mg to about 40 mg of the mineral blend, about 15 mg of the vitamin C. In accordance with examples of the present disclosure, some hydrogen peroxide may be added or formed in situ, e.g., from about 0.01 wt % to about 0.5 wt %, e.g., about 0.06 wt %.

### Example 4—Preparation of Nutritional Supplement Compositions (NS4)

A nutritional supplement composition (NS4) is prepared as a tablet by combining granules/powder of nicotinamide adenine dinucleotide and pyrroloquinoline quinone at about a 10:1 weight ratio. In this example, the nicotinamide adenine dinucleotide is an Oral Food Grade 99.7 wt % NAD+, meaning that very little content is in the form of NADH. This composition is then pressed into tablets with an excipient blend of microcrystalline cellulose, magnesium stearate, silicon dioxide, and dicalcium phosphate, available commercially under the tradename FIRMAPRESS. Each tablet in this example included about 100 mg of the nicotinamide adenine dinucleotide and about 10 mg of the pyrroloquinoline quinone compounds.

### Example 5—Preparation of Nutritional Supplement Compositions (NS5)

A nutritional supplement composition (NS5) is prepared as a tablet by combining granules/powder of nicotinamide adenine dinucleotide, pyrroloquinoline quinone, and urolithin A at about a 10:1:20: weight ratio. In this example, the nicotinamide adenine dinucleotide used is an Oral Food Grade 99.7 wt % NAD+, meaning that very little content is in the form of NADH. This composition is then pressed into tablets with an excipient blend of microcrystalline cellulose, magnesium stearate, silicon dioxide, and dicalcium phosphate, available commercially under the tradename FIRMAPRESS. Each tablet in this example includes about 100 mg of the nicotinamide adenine dinucleotide, about 10 mg of the pyrroloquinoline quinone compounds, and about 200 mg of the urolithin A

### Example 6—Preparation of Nutritional Supplement Compositions (NS6)

A nutritional supplement composition (NS6) is prepared as a tablet by combining granules/powder of methylthioninium chloride, urolithin A, and pyrroloquinoline quinone at about a 1:25:1 weight ratio. This composition is pressed into tablets with an excipient blend of microcrystalline cellulose, magnesium stearate, silicon dioxide, and dicalcium phosphate, available commercially under the tradename FIRMAPRESS. Each tablet in this example includes about 10 mg of the methylthioninium chloride, about 250 mg of the urolithin A, and about 10 mg of the pyrroloquinoline quinone compounds.

### Example 7—Preparation of Nutritional Supplement Compositions (NS7)

A nutritional supplement composition (NS7) is prepared as a tablet by combining granules/powder of methylthioninium chloride, urolithin A, pyrroloquinoline quinone, and nicotinamide adenine dinucleotide at about a 1:100:1:20 weight ratio. In this example, the nicotinamide adenine dinucleotide used is an Oral Food Grade 99.7 wt % NAD+, meaning that very little content is in the form of NADH. This composition is pressed into tablets with an excipient blend of microcrystalline cellulose, magnesium stearate, silicon dioxide, and dicalcium phosphate, available commercially under the tradename FIRMAPRESS. Each tablet in this example includes about 5 mg of the methylthioninium chloride, about 500 mg of the urolithin A, about 5 mg of the pyrroloquinoline quinone, and about 100 mg of the nicotinamide adenine dinucleotide (at 99.7 wt % NAD+).

### Example 8—Preparation of Nutritional Supplement Compositions (NS8)

A nutritional supplement composition (NS8) is prepared as a tablet by combining granules/powder of methylthioninium chloride, urolithin A, pyrroloquinoline quinone, and methylated vitamin B12 at about a 1:25:1:1 weight ratio. This composition is pressed into tablets with an excipient blend of microcrystalline cellulose, magnesium stearate, silicon dioxide, and dicalcium phosphate, available commercially under the tradename FIRMAPRESS. Each tablet in this example includes about 10 mg of the methylthioninium chloride, about 250 mg of the urolithin A, about 10 mg of the pyrroloquinoline quinone compounds, and about 10 mg of the methylated vitamin B12.

### Example 9—Preparation of Nutritional Supplement Compositions (NS9-NS18)

Several nutritional supplement compositions containing a GLP-1 agonist (NS9-NS18 shown in Table 1 below), or other similar compositions at different weight ratios of components as described herein, are prepared by co-formulating one of the nutritional supplement compositions of Examples 1-8 with a GLP-1 agonist, namely either semaglutide or tirzepatide. It is noted that other GLP-1 agonists can likewise be used than those described by way of example below.

TABLE 1

| | Example | | |
|---|---|---|---|
| Nutritional | Composition | | GLP-1 Agonist |
| Supplement | Combined with | Co-formulated | (Single Dose |
| ID | GLP-1 Agonist | GLP-1 Agonist | by Weight) |
| NS9 | NS1 | Semaglutide | 7 mg |
| NS10 | NS2 | Semaglutide | 10 mg |
| NS11 | NS3 | Semaglutide | 5 mg |
| NS12 | NS1 | Tirzepatide | 10 mg |
| NS13 | NS2 | Tirzepatide | 8 mg |
| NS14 | NS3 | Tirzepatide | 15 mg |
| NS15 | NS4 | Semaglutide | 7 mg |
| NS16 | NS4 | Tirzepatide | 10 mg |
| NS17 | NS6 | Semaglutide | 7 mg |
| NS18 | NS8 | Tirzepatide | 10 mg |

### Example 10—Enhancing Biological Functions in Subjects

The nutritional supplements of Examples 1-8 (NS1-NS8), or other similar compositions at different weight ratios of components as described herein, can be orally delivered to subjects for enhancing various biological functions. Table 2, as follows, provides a few examples accordingly.

TABLE 2

| Subject No. | Example | |
|---|---|---|
| (Age/Sex) | ID | Results |
| Subject 1 (34/F) | NS7 | Rapid weight loss in one month |
| Subject 2 (28/M) | *NS2 | Boost in morning energy (without caffeine), |
| | | improved effectiveness of testosterone |
| | | replacement and Cialis |
| Subject 3 (63/F) | NS2 | Improved general feeling and energy, |
| | | enhanced effects of other medications |
| Subject 4 (33/M) | **NS6 | Improved GLP-1 effectiveness |

*Co-administered with Oral Food Grade 99.7 wt % NAD+
**Co-administered with about 10 mg methylated vitamin B12 (similar to dosages to NS8, which includes the methylated vitamin B12 as part of the tablet); also co-administered with a GLP-1 agonist (7 mg dose semaglutide).

### Example 11—Combination Therapies

Combinations of various compositions can be used effectively to provide an additive or even synergistic effect as it relates to enhancing biological functions. For example, two or more nutritional supplement compositions as described herein can be co-administered on the same day (or together at the same time) to enhance various biological functions. For example:
NS1, NS2, or NS3 can be co-administered with NS4 or NS5;
NS1, NS2, or NS3 can be co-administered with NS6, NS7, or NS8;
NS4 or NS5 can be co-administered with NS6, NS7, or NS8;
One or more of NS1-NS8 can be co-administered with a nutritional supplement including a methylthioninium salt, caffeine, and L-theanine; and/or
One or more of NS1-NS8 can be co-administered with a GLP-1 agonist, such as semaglutide or tirzepatide.

It is to be understood that the above-referenced arrangements are illustrative of the application for the principles of the present disclosure. Thus, while the present technology has been described herein in connection with the exemplary embodiments, it will be apparent to those of ordinary skill in the art that numerous modifications and alternative arrangements can be made without departing from the principles and concepts of the disclosure as set forth in the claims.

1. A liquid nutritional supplement composition, comprising:
from about 85 wt % to about 98 wt % liquid carrier (or water)
from about 0.5 wt % to about 5 wt % mineral blend, wherein the mineral blend includes sodium, calcium, magnesium, potassium, and silicon each being independently present in the form of a mineral salt, a mineral oxide, or a mineral chloride; and
from about 0.25 wt % to about 3 wt % methylated vitamin B12, from about 0.25 wt % to about 3 wt % vitamin C, or both.

2. The liquid nutritional supplement composition of claim 1, wherein the methylated vitamin B12 and the vitamin C are both present in the liquid nutritional supplement composition.

3. The liquid nutritional supplement composition of claim 2, wherein a single dose of the liquid nutritional supplement composition is from about 0.5 mL to about 4.5 mL in volume, and the single dose includes:
from about 10 mg to about 75 mg of the mineral blend;
from about 1 mg to about 20 mg of the methylated vitamin B12; and
from about 5 mg to about 20 mg of the vitamin C.

4. (canceled)

5. The liquid nutritional supplement composition of claim 1, further comprising hydrogen peroxide formed in situ.

6. The liquid nutritional supplement composition of claim 1, wherein the mineral blend includes at least about 50 wt % mineral salt, mineral oxide, or mineral chloride in the form of magnesium salt, magnesium oxide, magnesium chloride, or a combination thereof based on a total weight of the mineral blend.

7. The liquid nutritional supplement composition of claim 1, further comprising a GLP-1 agonist.

8. The liquid nutritional supplement composition of claim 1, further comprising colloidal silver, black pepper, vitamin B6, vitamin E, manganese, a cannabinoid, nicotine, caffeine, L-theanine, or a combination thereof.

9. The liquid nutritional supplement composition of claim 1, further comprising nicotinamide adenine dinucleotide in the form of NADH, NAD+, or a combination thereof.

10. The liquid nutritional supplement composition of claim 1, wherein the nicotinamide adenine dinucleotide is present at a NAD+ to NADH weight ratio of at least about 99:1.

11. A method of enhancing a biological function in a subject, comprising:
orally administering the liquid nutritional supplement composition of claim 1 to a subject.

12. The method of claim 11, further comprising orally co-administering the liquid nutritional supplement composition with a GLP-1 agonist co-formulated as part of the liquid nutritional supplement composition, or as a separate dosage form at the same time as the liquid nutritional supplement composition or at a different time during a single day relative the liquid nutritional supplement composition, wherein the GLP-1 agonist includes dulaglutide, exenatide, liraglutide, lixisenatide, semaglutide, tirzepatide, or a combination thereof.

13. (canceled)

14. The method of claim 12, wherein the GLP-1 agonist includes the semaglutide.

15. The method of claim 12, wherein the subject is orally administered the liquid nutritional supplement composition and the GLP-1 agonist for promoting weight loss, providing long-term weight management, or both.

16. The method of claim 11, further comprising orally co-administering from about 10 mg to about 200 mg nicotinamide adenine dinucleotide to the subject on a daily basis, wherein the nicotinamide adenine dinucleotide has an NAD+ to NADH weight ratio of at least about 99:1.

17. (canceled)

18. The method of claim 11, wherein the subject is orally administered the liquid nutritional supplement composition for promoting mitochondrial health, cellular health, weight loss, long-term weight management, cardiovascular health, brain health and function, or a combination thereof.

19. The method of claim 11, further comprising orally co-administering a second nutritional supplement composition to the subject at the same time or at different times during a single day, wherein the second nutritional supplement composition includes:
nicotinamide adenine dinucleotide in the form of NADH, NAD+, or a combination thereof, and pyrroloquinoline quinone, wherein the nicotinamide adenine dinucleotide and the pyrroloquinoline quinone are present in the nutritional supplement composition at a weight ratio from about 1:40 to about 1:2; or
a methylthioninium salt, urolithin A, and pyrroloquinoline quinone, wherein the methylthioninium salt to urolithin A weight ratio is from about 1:600 to about 1:4 and the methylthioninium salt to pyrroloquinoline quinone weight ratio is from about 1:20 about 50:1.

20. (canceled)

21. A nutritional supplement composition, comprising:
nicotinamide adenine dinucleotide in the form of NADH, NAD+, or a combination thereof; and
pyrroloquinoline quinone,
wherein the nicotinamide adenine dinucleotide and the pyrroloquinoline quinone are present in the nutritional supplement composition at a weight ratio from about 1:40 to about 1:2.

22. The nutritional supplement composition of claim 21, wherein the nicotinamide adenine dinucleotide is present at a NAD+ to NADH weight ratio of at least about 99:1.

23. (canceled)

24. The nutritional supplement composition of claim 21, wherein a single dose of the nutritional supplement composition includes from about 50 mg to about 200 mg of the nicotinamide adenine dinucleotide and from about 5 mg to about 25 mg of the pyrroloquinoline quinone.

25. The nutritional supplement composition of claim 21, further comprising a GLP-1 agonist.

26. (canceled)

27. The nutritional supplement composition of claim 21, wherein the nutritional supplement composition incudes an excipient blend of microcrystalline cellulose, magnesium stearate, silicon dioxide, and dicalcium phosphate.

28. The nutritional supplement composition of claim 21, further comprising urolithin A.

29. The nutritional supplement composition of claim 28, wherein the pyrroloquinoline quinone and the urolithin A are present in the nutritional supplement composition at a weight ratio from about 1:100 to about 1:2.

30. (canceled)

31. A method of enhancing a biological function in a subject, comprising:
orally administering the nutritional supplement composition of claim 21 to a subject.

32. The method of claim 31, further comprising orally co-administering the nutritional supplement composition with a GLP-1 agonist co-formulated as part of the nutritional supplement composition, or as a separate dosage form at the same time as the nutritional supplement composition or at a different time during a single day relative the nutritional supplement composition, wherein the the GLP-1 agonist includes dulaglutide, exenatide, liraglutide, lixisenatide, semaglutide, tirzepatide, or a combination thereof.

33. (canceled)

34. The method of claim 32, wherein the GLP-1 agonist includes semaglutide.

35. The method of claim 32, wherein the subject is orally administered the nutritional supplement composition and the GLP-1 agonist for promoting weight loss, providing long-term weight management, or both.

36. The method of claim 31, further comprising orally co-administering a liquid nutritional supplement composition to the subject at the same time or at different times during a single day, wherein the liquid nutritional supplement composition includes:
an aqueous liquid carrier, from about 0.5 wt % to about 5 wt % of a mineral blend, wherein the mineral blend includes sodium, calcium, magnesium, potassium, and silicon each being independently present in the form of a mineral salt, a mineral oxide, or a mineral chloride, and methylated vitamin B12 or vitamin C or both, wherein a single dose from about 0.5 mL to about 2.5 mL of the liquid nutritional supplement composition includes from about 1 mg to about 20 mg of the methylated vitamin B12 when present and from about 5 mg to about 20 mg of the vitamin C when present; or
a methylthioninium salt, urolithin A, and pyrroloquinoline quinone, wherein the methylthioninium salt to urolithin A weight ratio is from about 1:600 to about 1:4 and the methylthioninium salt to pyrroloquinoline quinone weight ratio is from about 1:20 about 50:1.

37. (canceled)

38. The method of claim 37, wherein the second nutritional supplement also includes a methylated vitamin B12 at a methylthioninium salt to methylated vitamin B12 weight ratio of about 1:20 to about 50:1.

39. (canceled)

40. The method of claim 31, wherein the subject is orally administered the nutritional supplement composition for enhancing mitochondrial function, biogenesis, NAD+ production and utilization, cellular metabolism, energy production, antioxidant defense, energy brain health and function, cellular function, or a combination thereof.

41. A nutritional supplement composition, comprising:
a methylthioninium salt;
urolithin A;
pyrroloquinoline quinone; and
methylated vitamin B12, nicotinamide adenine dinucleotide in the form of NADH, NAD+, or a combination thereof,
wherein the nutritional supplement composition has a methylthioninium salt to urolithin A weight ratio from about 1:600 to about 1:4, a methylthioninium salt to pyrroloquinoline quinone weight ratio from about 1:20 to about 50:1, a methylthioninium salt to methylated vitamin B12 weight ratio from about 1:20 to about 50:1 if present, and a methylthioninium salt to nicotinamide adenine dinucleotide weight ratio from about 2:5 to about 200:1 if present.

42. The nutritional supplement composition of claim 41, wherein a single oral dosage form includes:
from about 1 mg to about 25 mg of the methylthioninium salt,
from about 100 mg to about 600 mg of urolithin A,
from about 0.5 mg to about 20 mg of the pyrroloquinoline quinone, and
from about 0.5 mg to about 20 mg methylated vitamin B12, from about 10 mg to about 200 mg of the nicotinamide adenine dinucleotide, or a combination thereof.

43-44. (canceled)

45. The nutritional supplement composition of claim 41, wherein the nicotinamide adenine dinucleotide is present and included at a NAD+ to NADH weight ratio of at least about 99:1.

46. The nutritional supplement composition of claim 41, further comprising a GLP-1 agonist.

47. (canceled)

48. The nutritional supplement composition of claim 41, wherein the nutritional supplement composition incudes an excipient blend of microcrystalline cellulose, magnesium stearate, silicon dioxide, and dicalcium phosphate.

49. The nutritional supplement composition of claim 41, wherein the methylthioninium salt and the pyrroloquinoline quinone are present at a weight ratio from about 1:20 to about 30:1, and wherein the urolithin A and the pyrroloquinoline quinone are present at a urolithin A to pyrroloquinoline quinone weight ratio from about 5:1 to about 1200:1.

50. (canceled)

51. A method of enhancing a biological function in a subject, comprising:
orally administering the nutritional supplement composition of claim 41 to a subject.

52. The method of claim 51, wherein the nicotinamide adenine dinucleotide is present in the nutritional supplement composition and included at a NAD+ to NADH weight ratio of at least about 99:1.

53. The method of claim 51, further comprising orally co-administering the nutritional supplement composition with a GLP-1 agonist co-formulated as part of the nutritional supplement composition, or as a separate dosage form at the same time as the nutritional supplement composition or at a different time during a single day relative the nutritional supplement composition, wherein the GLP-1 agonist includes dulaglutide, exenatide, liraglutide, lixisenatide, semaglutide, tirzepatide, or a combination thereof.

54. (canceled)

55. The method of claim 53, wherein the GLP-1 agonist includes semaglutide.

56. The method of claim 53, wherein the subject is orally administered the nutritional supplement composition and the GLP-1 agonist for promoting weight loss, providing long-term weight management, or both.

57. The method of claim 51, further comprising orally co-administering a liquid nutritional supplement composition to the subject at the same time or at different times during a single day, wherein the liquid nutritional supplement composition includes:
an aqueous liquid carrier;
from about 0.5 wt % to about 5 wt % of a mineral blend, wherein the mineral blend includes sodium, calcium, magnesium, potassium, and silicon each being independently present in the form of a mineral salt, a mineral oxide, or a mineral chloride; and
methylated vitamin B12, vitamin C, or both,
wherein a single dose from about 0.5 mL to about 2.5 mL of the liquid nutritional supplement composition includes from about 1 mg to about 20 mg of the methylated vitamin B12 when present and from about 5 mg to about 20 mg of the vitamin C when present.

58. The method of claim 51, wherein:
the subject is orally administered the nutritional supplement composition for enhancing mitochondrial health, supporting weight loss, long-term management, enhance nicotinamide adenine dinucleotide production, enhance mitochondrial mitophagy, or a combination thereof;
the nutritional supplement composition is dosed on a daily basis with sufficient methylthioninium salt to stimulate ATP production and sufficient pyrroloquinoline quinone to enhance nicotinamide adenine dinucleotide production, mitochondrial mitophagy, or a combination thereof; or
the nicotinamide adenine nucleotide is not included in the nutritional supplement composition, but the adenine nucleotide is co-administered at from about 10 mg to about 200 mg together or on the same day as the nutritional supplement composition.

61. A method of enhancing weight loss or supporting long-term weight management, comprising:
orally co-administering a GLP-1 agonist; and
a nutritional supplement composition including:
a methylthioninium salt,
urolithin A, and
pyrroloquinoline quinone, and
wherein the nutritional supplement composition has a methylthioninium salt to urolithin A weight ratio from about 1:600 to about 1:4, and a methylthioninium salt to pyrroloquinoline quinone weight ratio from about 1:20 to about 50:1.

62. The method of claim 61, wherein the GLP-1 agonist is co-formulated as part of the nutritional supplement composition.

63. The method of claim 61, wherein the GLP-1 agonist is a separate dosage form that is co-administered at the same time as the nutritional supplement composition or at a different time during a single day relative the nutritional supplement composition.

64. The method of claim 61, wherein the nutritional supplement composition further includes a methylated vitamin B12 at a methylthioninium salt to methylated vitamin B12 weight ratio from about 1:20 to about 50:1.

65. The method of claim 61, wherein a single oral dosage form includes:
from about 1 mg to about 25 mg of the methylthioninium salt; and
from about 100 mg to about 600 mg of urolithin A, and
from about 0.5 mg to about 20 mg of the pyrroloquinoline quinone.

66. The method of claim 63, wherein the nutritional supplement composition further includes a methylated vitamin B12 and the single oral dosage form includes from about 0.5 mg to about 20 mg methylated vitamin B12.

67. The method of claim 61, wherein the nutritional supplement composition incudes an excipient blend of microcrystalline cellulose, magnesium stearate, silicon dioxide, and dicalcium phosphate.

68. A combination therapy, comprising co-administering two or more nutritional supplement compositions within a single day to a subject, the two or more nutritional supplement compositions including:
a first nutritional supplement composition including:
from about 85 wt % to about 98 wt % liquid carrier, from about 0.5 wt % to about 5 wt % of a mineral blend, from about 0.25 wt % to about 3 wt % methylated vitamin B12, and from about 0.25 wt % to about 3 wt % vitamin C, wherein the mineral blend includes sodium, calcium, magnesium, potassium, and silicon each being independently present in the form of a mineral salt, a mineral oxide, or a mineral chloride;
a second nutritional supplement composition including:
nicotinamide adenine dinucleotide in the form of NADH, NAD+, or a combination thereof, and
pyrroloquinoline quinone,
wherein the second nutritional supplement composition has a nicotinamide adenine dinucleotide to pyrroloquinoline quinone weight ratio from about 1:40 to about 1:2;
a third nutritional supplement composition including:
a methylthioninium salt,
urolithin A, and
pyrroloquinoline quinone,
wherein the third nutritional supplement composition has a methylthioninium salt to urolithin A weight ratio from about 1:600 to about 1:4 and a methylthioninium salt to pyrroloquinoline quinone weight ratio from about 1:20 to about 50:1;
a fourth nutritional supplement composition, including:
a methylthioninium salt,
caffeine, and
L-theanine,
wherein the fourth nutritional supplement composition has a methylthioninium chloride to the caffeine weight ratio from about 1:75 to about 1:4, a methylthioninium chloride to the L-theanine weight ratio from about 1:200 to about 1:10, and a caffeine to the L-theanine weight ratio from about 1:5 to about 1:1.

69-70. (canceled)

71. The combination therapy of claim 68, further comprising co-administering a GLP-1 agonist within the single day to the subject as a co-formulated dosage with one or more of the first, second, third, or fourth nutritional supplement composition, or as a separate dosage form.
